(19) United States
(12) Patent Application Publication
(10) Pub. No.: US 2026/0130367 A1
(43) Pub. Date: May 14, 2026

(54) BACTERICIDAL, FUNGICIDAL, AND NEMATICIDAL FORMULATIONS OF PHENOXYETHANOL FOR AGRICULTURAL USE IN PLANTS

(71) Applicant: Química Agronómica de México S. de R.L. de C.V., Chihuahua (MX)

(72) Inventor: Miguel Enrique Alvarado LICON, Chihuahua (MX)

(73) Assignee: Química Agronómica de México S. de R.L. de C.V., Chihuahua (MX)

(21) Appl. No.: 19/384,603

(22) Filed: Nov. 10, 2025

Related U.S. Application Data
(63) Continuation of application No. PCT/IB2025/061416, filed on Nov. 7, 2025.
(60) Provisional application No. 63/718,351, filed on Nov. 8, 2024.
(60) Provisional application No. 63/883,872, filed on Sep. 18, 2025.

(51) Int. Cl. A01N 31/14; A01P 1/00; A01P 3/00; A01P 5/00

(52) U.S. Cl. CPC A01N 31/14; A01P 1/00; A01P 3/00; A01P 5/00

(57) ABSTRACT

A method of treating and/or preventing a disease in plants, including a step of administering a composition comprising phenoxyethanol to a plant is disclosed. In addition, a method of treating and/or preventing a nematodal infestation in plants, comprising a step of administering a composition comprising phenoxyethanol to a plant is disclosed. Compositions comprising phenoxyethanol used in such methods are also disclosed.

This application claims benefit to U.S. Provisional Application No. 63/718,351, filed Nov. 8, 2024; and U.S. Provisional Application No. 63/883,872, filed Sep. 18, 2025; the entire contents of each of which is herein incorporated by reference.

### BACKGROUND

In modern agriculture, challenges and opportunities are constant, and one of the greatest current challenges relates to the control of pathogenic organisms in crops. In recent years, there has been a resurgence of emerging diseases, namely diseases caused by pathogens that were previously eradicated from certain agricultural regions but, due to climate change and other variables, have returned with greater virulence. These pathogens are not only attacking the crops they previously affected, but are also spreading to new plant species, posing a serious risk to the economies of farmers, agricultural industries, and the productive regions of various countries.

The resurgence of these pathogens spans a broad spectrum, including phytopathogenic fungi, phytopathogenic bacteria, certain types of viruses, and nematodes. These organisms can have a devastating impact on crops if appropriate control measures are not implemented. For this reason, it is imperative to have products and strategies that are effective in curbing the spread of these diseases and improving the management of parasitic organisms that threaten agricultural systems. Thus, there is a need for the development of innovative and unique active ingredients that provide effective and long-lasting solutions.

The development use of specialized active ingredients will not only help improve crop yields and health, but will also allow for the sustainable development of affected agricultural regions. This translates into better harvests, broader economic opportunities for farmers, and a harmonious coexistence between conventional agricultural practices and new biological and chemical methodologies. Thus, the common goals of agricultural welfare and long-term sustainability can be achieved.

Accordingly, a goal of the present disclosure is to provide a new, innovative, and unique product for controlling pathogenic organisms in and on plants, as well as a method for controlling such pathogenic organisms using the product. Such control may include both prevention and treatment of the pathogenic organisms and the problems that they cause.

### SUMMARY

Applicants have discovered that a promising active ingredient in the context of pathogen control is phenoxyethanol, a substance that has been primarily used not in agriculture, but rather in the cosmetic industry. The present disclosure relates to applying this active ingredient in effective concentrations in an agricultural field, usually very low concentrations, with the aim of slowing, containing, and controlling the spread of pathogens, including bacteria, fungi, and nematodes.

A main purpose of this disclosure is to provide a new formulation acceptable for agricultural use. The formulation is effective to prevent, treat, and control diseases caused by bacteria, fungus, and nematodes in plants, while also providing for an environmentally-friendly composition, thereby permitting its authorized use in those countries that have high registry standards and those countries in which the use of other materials, such as antibiotics, have been controlled or forbidden.

The formulation comprises phenoxyethanol as active ingredient. The phenoxyethanol may be mixed with agriculturally acceptable excipients, including emulsifiers. The agriculturally acceptable formulation can be deposited in and mixed with a reasonable amount of water, which may be distilled water, to be sprinkled in very thin droplets of water “to the point of dripping” via appropriate equipment to the crop that it is intended to protect, in which bacterial, fungicidal, or nematodal damage may be present and would otherwise continue to harm the plants. The agriculturally acceptable formulation can also be applied to crops that do not exhibit any bacterial, fungicidal, or nematodal damage, so as to protect them from future damage. The agriculturally acceptable formulation thereby avoids losses exceeding the profitable economic thresholds for the food producer.

The present disclosure relates, in part, to a composition comprising phenoxyethanol, a method of using the composition comprising phenoxyethanol, and the use of the composition comprising phenoxyethanol. The disclosure below provides additional detail regarding the contents of the composition and how it may be used and applied to plants.

Pathogenic organisms can attack different parts of the plant, such as leaves, stems, and roots, causing severe damage that affects the plant's photosynthetic capacity and causes visible symptoms such as wilting, leaf spots, blights, downy mildew, and galls in the case of nematodes. If not controlled in time, these pathogens can cause catastrophic losses, severely affecting crop productivity and, consequently, the farmer's and region's economy. The present disclosure aims to provide a product and method of controlling these pathogens.

Included in the present disclosure is a composition for agricultural use comprising phenoxyethanol. Certain embodiments additionally include at least one item selected from the group consisting of tannins, bactericides, resistance inductors, biopesticides, biostimulants, biofertilizers, botanical pesticides, fungicides, fertilizers, hormones, and nematicides in the composition.

In another embodiment of the present disclosure, the composition includes phenoxyethanol in an amount of from 0.01 ml/L to 100 ml/L of the composition. A further embodiments include any of the previously-mentioned compositions wherein the phenoxyethanol is present in the composition in an amount of from 1 ml/L to 20 ml/L of the composition, or an amount of from 1 ml/L to 20 ml/L of the composition, or an amount of from 1 ml/L to 10 ml/L of the composition, or an amount of from 2 ml/L to 10 ml/L of the composition, or an amount of from 3 ml/L to 9 ml/L of the composition.

Another embodiment of the present disclosure is the composition disclosed in any of the embodiments herein, wherein the phenoxyethanol is present in the composition in an amount sufficient to treat and/or prevent bacteria and/or fungal, or an amount sufficient to kill nematodes or prevent nematodal infestations.

Another embodiment of the present disclosure is a method of treating and/or preventing a disease in plants, comprising a step of administering the composition according to any of the embodiments herein to a plant.

Another embodiment of the present disclosure is a method of treating and/or preventing a nematodal infestation in plants, comprising a step of administering the composition according to any of the embodiments herein to a plant.

Another embodiment of the present disclosure is a method according to any of the embodiments herein, comprising administering the composition to at least one of the plant's foliage, stem, canopy, trunk, roots, shoots, twigs, or flowers. Additional embodiments include these methods comprising administering the composition to at least one of the plant's seeds or rhizomes; administering the composition of any of the embodiments herein to the plant at least twice at an interval of from 1-21 days; and/or administering during the plant's seedling stage, transplant stage, vegetative stage, pre-bloom stage, full-bloom stage, post-bloom stage, fruit set stage, or dormancy.

Further embodiments include the methods of any of the embodiments herein, wherein the plant is a vegetable plant, a cereal plant, a fruit plant, a nut plant, or sugar cane. An additional embodiment includes where the plant is a fruit tree.

Further embodiments include the methods of any of the embodiments herein, wherein the disease is caused by a bacteria or fungi. The bacteria or fungi may be Clavibacter sp., Pseudomonas sp., Ralstonia sp., Pectobacterium sp., Xanthomonas sp., Erwinia sp., Alternaria sp., Fusarium sp., Colletotrichum sp., Phythopthora sp., Botritys sp., or Bipolaris sp.

Additional embodiments include the use of the composition according to any of the embodiments herein to treat and/or prevent a disease in plants, or to treat and/or prevent a nematodal infestation in plants. An additional embodiment includes this use comprising using the method according to any of embodiments herein.

Accordingly, the following embodiments are some of the embodiments disclosed herein:

An embodiment that includes a method of treating and/or preventing a disease in plants, comprising a step of administering a composition comprising phenoxyethanol to a plant.

An embodiment that includes a method of treating and/or preventing a nematodal infestation in plants, comprising a step of administering a composition comprising phenoxyethanol to a plant.

An embodiment that includes the method of any of the embodiments herein, comprising administering the composition to at least one of the plant's foliage, stem, canopy, trunk, roots, shoots, twigs, or flowers.

An embodiment that includes the method of any of the embodiments herein, comprising administering the composition to at least one of the plant's seeds or rhizomes.

An embodiment that includes the method of any of the embodiments herein, wherein the composition is administered to the plant at least twice at an interval of from 1-21 days.

An embodiment that includes the method of any of the embodiments herein, wherein the composition is administered during the plant's seedling stage, transplant stage, vegetative stage, pre-bloom stage, full-bloom stage, post-bloom stage, fruit set stage, or dormancy.

An embodiment that includes the method of any of the embodiments herein, wherein the plant is a vegetable plant, a cereal plant, a fruit plant, a nut plant, or sugar cane.

An embodiment that includes the method of any of the embodiments herein, wherein the plant is a fruit tree.

An embodiment that includes the method of any of the embodiments herein, wherein the disease is caused by a bacteria or fungi.

An embodiment that includes the method of any of the embodiments herein, wherein the disease is caused by Clavibacter sp., Pseudomonas sp., Ralstonia sp., Pectobacterium sp., Xanthomonas sp., Erwinia sp., Alternaria sp., Fusarium sp., Colletotrichum sp., Phythopthora sp., Botritys sp., or Bipolaris sp.

An embodiment that includes the use of a composition comprising phenoxyethanol claims to treat and/or prevent a disease in plants, or to treat and/or prevent a nematodal infestation in plants.

An embodiment that includes the use of a composition according to any of the embodiments herein, comprising using the method according to any of the embodiments herein.

An embodiment that includes the composition of any of the embodiments herein, comprising phenoxyethanol configured to be applied to plants and which is used to treat and/or prevent a disease in plants or a nematodal infestation in plants.

An embodiment that includes the composition of any of the embodiments herein, wherein the phenoxyethanol is present in the composition in an amount of from 0.01 ml/L to 100 ml/L of the composition.

An embodiment that includes the composition of any of the embodiments herein, wherein the phenoxyethanol is present in the composition in an amount of from 1 ml/L to 20 ml/L of the composition.

An embodiment that includes the composition of any of the embodiments herein, wherein the phenoxyethanol is present in the composition in an amount of from 1 ml/L to 10 ml/L of the composition.

An embodiment that includes the composition of any of the embodiments herein, wherein the phenoxyethanol is present in the composition in an amount of from 2 ml/L to 10 ml/L of the composition.

An embodiment that includes the composition of any of the embodiments herein, wherein the phenoxyethanol is present in the composition in an amount of from 3 ml/L to 9 ml/L of the composition.

An embodiment that includes the composition of any of the embodiments herein, wherein the phenoxyethanol is present in the composition in an amount sufficient to treat and/or prevent bacteria and/or fungal diseases, or an amount sufficient to kill nematodes or prevent nematodal infestations.

### BRIEF DESCRIPTION OF THE DRAWINGS

FIG. 1 shows the effect of different concentrations of certain embodiments of the present disclosure on Clavibacter sp.

FIG. 2 shows the effect of different compositions of certain embodiments of the present disclosure on Pseudomonas sp.

FIG. 3 shows the effect of different compositions of certain embodiments of the present disclosure on Ralstonia sp.

FIG. 4 shows the effect of different compositions of certain embodiments of the present disclosure on Pectobacterium sp.

FIG. 5 shows the effect of different compositions of certain embodiments of the present disclosure on Xanthomonas sp.

FIG. 6 shows the effect of different compositions of certain embodiments of the present disclosure on Erwinia sp.

FIG. 7 shows the effect of different compositions of certain embodiments of the present disclosure on Alternaria sp.

FIG. 8 shows the effect of different compositions of certain embodiments of the present disclosure on Fusarium sp.

FIG. 9 shows the effect of different compositions of certain embodiments of the present disclosure on Colletotrichum sp.

FIG. 10 shows the effect of different compositions of certain embodiments of the present disclosure on Phythopthora sp.

FIG. 11 shows the effect of different compositions of certain embodiments of the present disclosure on Botritys sp.

FIG. 12 shows the effect of different compositions of certain embodiments of the present disclosure on Bipolaris sp.

FIG. 13 shows a root from which nematodes were extracted.

FIGS. 14(a) and 14(b) show the effect of an embodiment of the present disclosure on a nematode.

FIGS. 15(a) and 15(b) show the effect of an embodiment of the present disclosure on a nematode.

FIGS. 16(a), 16(b), and 16(c) show the effect of an embodiment of the present disclosure on a nematode.

FIG. 17 shows the biological effectiveness for the control of root-knot nematodes (Meloidogyne incognita) in greenhouse tomato (severity of root galling).

FIG. 18 shows the biological effectiveness for the control of root-knot nematodes (Meloidogyne incognita) in greenhouse tomato (density of Meloidogyne incognita J2 per 100 cm³ of soil).

FIG. 19 shows the biological effectiveness for the control of angular leaf spot (Pseudomonas syringae pv. lachrymans) in Zucchini.

FIG. 20 shows the biological effectiveness for the control of late blight (Phytophthora infestans) in Potato.

FIG. 21 shows test laboratory test results involving established colonies of Pseudomonas sp., Botrytis sp., and Colletotrichum sp.

### DETAILED DESCRIPTION

The agriculturally acceptable formulation of the present disclosure may include phenoxyethanol as active ingredient mixed with agriculturally acceptable excipients. Such agriculturally acceptable excipients include, for example, tannins, bactericides, resistance inductors, biopesticides, fungicides, fertilizers, hormones, nematicides, and the like.

Phenoxyethanol has the following chemical structure:

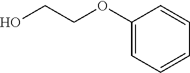

It is also envisioned that analogues and derivatives of phenoxyethanol may also be used, so long as those compounds provide for the antifungal, antibacterial, and anti-nematodal effects found with phenoxyethanol.

The phenoxyethanol may be mixed with water prior to application to a crop. The water may be distilled water. The amount of water added to the phenoxyethanol to form an agriculturally acceptable composition of the present disclosure is not particularly limited, and the phenoxyethanol may be applied in mixtures containing, for example, from 0% to 50% water by volume, in some embodiments 60% water by volume, in some embodiments 70% water by volume, in some embodiments 80% water by volume, in some embodiments 90% water by volume, in some embodiments 95% water by volume, in some embodiments 98% water by volume, in some embodiments 99% water by volume, in some embodiments 99.9% water by volume, and in some embodiments 99.99% water by volume. The ranges of water content that may be present include the endpoints above.

The amount of and concentration of phenoxyethanol present in the agriculturally acceptable formulation is enough to control, for example, to prevent and/or treat, a desired pathogen, including an undesired bacteria or an undesired fungus, or enough to control, for example to kill or prevent infestation of an undesired nematode. Suitable amounts of phenoxyethanol that may be present in the agriculturally acceptable formulation include, for example, greater than 0.01 ml/L, 0.1 ml/L, or 1 ml/L of the total formulation. The upper limit of phenoxyethanol is not particularly limited. In other embodiments, amounts as low as 0.1 ml/L or 0.01 ml/L of the total formulation may be phenoxyethanol. Preferred amounts of phenoxyethanol include concentrations from 1 ml/L to 9 ml/L. More preferred amounts of phenoxyethanol include concentrations from 2 ml/L to 9 ml/L. More preferred amounts of phenoxyethanol include concentrations from 3 ml/L to 9 ml/L. More preferred amounts of phenoxyethanol include concentrations from 4 ml/L to 9 ml/L. More preferred amounts of phenoxyethanol include concentrations from 5 ml/L to 9 ml/L. Additionally preferred amounts of phenoxyethanol include concentrations above 4 ml/L. Additionally preferred amounts of phenoxyethanol include concentrations above 5 ml/L. Additionally preferred amounts of phenoxyethanol include concentrations above 6 ml/L. Additionally preferred amounts of phenoxyethanol include concentrations above 7 ml/L. Additionally preferred amounts of phenoxyethanol include concentrations above 8 ml/L. Additionally preferred amounts of phenoxyethanol include concentrations above 9 ml/L. Additionally preferred amounts of phenoxyethanol include concentrations above 10 ml/L. The upper limit of the amount or concentration of phenoxyethanol may be determined based on the treated pathogen or other factors, such as environmental concerns. All concentrations above are based on the total concentration of phenoxyethanol in the composition.

The maximum amount of phenoxyethanol that may be present in the composition is not particularly limited, but in some embodiments the maximum may be 20 ml/L, 30 ml/L, 40 ml/L, 50 ml/L, 60 ml/L, 70 ml/L, 80 ml/L, 90 ml/L, or 100 ml/L. All concentrations above are based on the total concentration of phenoxyethanol in the composition.

Accordingly, additional embodiments of the present disclosure include amounts of phenoxyethanol of from 0.01 ml/L to 100 ml/L; from 0.1 ml/L to 100 ml/L; from 1 ml/L to 100 ml/L; from 2 ml/L to 100 ml/L; from 3 ml/L to 100 ml/L; from 4 ml/L to 100 ml/L; from 5 ml/L to 100 ml/L; from 6 ml/L to 100 ml/L; from 7 ml/L to 100 ml/L; from 8 ml/L to 100 ml/L; from 9 ml/L to 100 ml/L; from 0.01 ml/L to 90 ml/L; from 0.1 ml/L to 90 ml/L; from 1 ml/L to 90 ml/L; from 2 ml/L to 90 ml/L; from 3 ml/L to 90 ml/L; from 4 ml/L to 90 ml/L; from 5 ml/L to 90 ml/L; from 6 ml/L to 90 ml/L; from 7 ml/L to 90 ml/L; from 8 ml/L to 90 ml/L; from 9 ml/L to 90 ml/L; from 0.01 ml/L to 80 ml/L; from 0.1 ml/L to 80 ml/L; from 1 ml/L to 80 ml/L; from 2 ml/L to 80 ml/L; from 3 ml/L to 80 ml/L; from 4 ml/L to 80 ml/L; from 5 ml/L to 80 ml/L; from 6 ml/L to 80 ml/L; from 7 ml/L to 80 ml/L; from 8 ml/L to 80 ml/L; from 9 ml/L to 80 ml/L; from 0.01 ml/L to 70 ml/L; from 0.1 ml/L to 70 ml/L; from 1 ml/L to 70 ml/L; from 2 ml/L to 70 ml/L; from 3 ml/L to 70 ml/L; from 4 ml/L to 70 ml/L; from 5 ml/L to 70 ml/L; from 6 ml/L to 70 ml/L; from 7 ml/L to 70 ml/L; from 8 ml/L to 70 ml/L; from 9 ml/L to 70 ml/L; from 0.01 ml/L to 60 ml/L; from 0.1 ml/L to 60 ml/L; from 1 ml/L to 60 ml/L; from 2 ml/L to 60 ml/L; from 3 ml/L to 60 ml/L; from 4 ml/L to 60 ml/L; from 5 ml/L to 60 ml/L; from 6 ml/L to 60 ml/L; from 7 ml/L to 60 ml/L; from 8 ml/L to 60 ml/L; from 9 ml/L to 60 ml/L; from 0.01 ml/L to 50 ml/L; from 0.1 ml/L to 50 ml/L; from 1 ml/L to 50 ml/L; from 2 ml/L to 50 ml/L; from 3 ml/L to 50 ml/L; from 4 ml/L to 50 ml/L; from 5 ml/L to 50 ml/L; from 6 ml/L to 50 ml/L; from 7 ml/L to 50 ml/L; from 8 ml/L to 50 ml/L; from 9 ml/L to 50 ml/L; from 0.01 ml/L to 40 ml/L; from 0.1 ml/L to 40 ml/L; from 1 ml/L to 40 ml/L; from 2 ml/L to 40 ml/L; from 3 ml/L to 40 ml/L; from 4 ml/L to 40 ml/L; from 5 ml/L to 40 ml/L; from 6 ml/L to 40 ml/L; from 7 ml/L to 40 ml/L; from 8 ml/L to 40 ml/L; from 9 ml/L to 40 ml/L; from 0.01 ml/L to 30 ml/L; from 0.1 ml/L to 30 ml/L; from 1 ml/L to 30 ml/L; from 2 ml/L to 30 ml/L; from 3 ml/L to 30 ml/L; from 4 ml/L to 30 ml/L; from 5 ml/L to 30 ml/L; from 6 ml/L to 30 ml/L; from 7 ml/L to 30 ml/L; from 8 ml/L to 30 ml/L; from 9 ml/L to 30 ml/L; from 0.01 ml/L to 20 ml/L; from 0.1 ml/L to 20 ml/L; from 1 ml/L to 20 ml/L; from 2 ml/L to 20 ml/L; from 3 ml/L to 20 ml/L; from 4 ml/L to 20 ml/L; from 5 ml/L to 20 ml/L; from 6 ml/L to 20 ml/L; from 7 ml/L to 20 ml/L; from 8 ml/L to 20 ml/L; or from 9 ml/L to 20 ml/L in the agriculturally acceptable formulation. All concentrations above are based on the total concentration of phenoxyethanol in the composition.

Suitable tannins that may be used include, for example, tannins disclosed in U.S. Pat. No. 10,757,942, the content of which are incorporated herein by reference in its entirety. For example, tannins that may be used in the agriculturally acceptable formulation include any type of tannin, such as but not limited to ellagic, pyrogallol, or gallic tannins. Also “pseudo-tannins” can be used such as gallic acid, such atrihydroxybenzoic acid, or ellagic acid. Castalagin and vescalagin (both are ellagic tannins) are examples of such tannins, but the tannins are not limited thereto, and other tannins may also be used. For example, flavan-3-ols, such as catechin, epicatechin gallate, epigallocatechin, epigallocatechin gallate, proanthocyanidins, theaflavins, and thearubigins may be used. Chlorogenic acids (CGA), such as hydroxycinnamic acids, caffeic acid, ferulic acid, and p-coumaric acid, and quinic acid may also be used. In addition, ipecacuanhic acids, such as metine, cephaeline, emetamine, ipecacuanhic acid, psychotrine, and O-methylpsychotrine can also be used. Tannins such as roburine, castaline, castanopsinines, casuarictine, excoecarianine, excoecarinines, grandinine, pterocarinine, punicacorteine, punicalagine, rhoipteleanines, roburines, vescaline, gallic acid, ellagic acid, procianidine may also be used. Importantly, the above tannins are exemplary only, and any other tannin may be used. The tannins may be used alone or in combination with one another. Natural or synthetic tannins may be used. In exemplary embodiments, the tannin may be one or more of a flavonoid, procyanidin, proanthocyanin, prodelfinidin, profisetidine, proanthocyanidin, cyanidin, anthocyanin, and catechin. Formulations of the present disclosure may also comprise, in some instances, flavanones and/or flavanols, for example.

The amount of tannins that may be present in the agriculturally acceptable formulation is not particularly limited, but may be an amount of from 0.01% by mass to 99% by mass. For example, they may be present in the formulation in an amount of from 0.1% by mass to 50% by mass. As another example, they may be present in the formulation in an amount of from 0.1% by mass to 10% by mass. As another example, they may be present in the formulation in an amount of from 0.1% by mass to 1% by mass, from 0.5% by mass to 5% by mass, from 1% by mass to 10% by mass, from 10% to 20% by mass, from 20% to 30% by mass, from 30% to 40% by mass, from 40% to 50% by mass, from 50% to 60% by mass, from 60% to 70% by mass, from 70% to 80% by mass, and from 80% to 90% by mass. As another example, they may be present in the formulation in an amount of from 1% by mass to 25% by mass, from 10% by mass to 50% by mass, from 25% by mass to 75% by mass, or from 50% by mass to 99% by mass. However, the amount of tannin is not particularly limited so long as the amount provides for the antibacterial or antifungal effects disclosed herein. The tannins may be used and applied to plants in amounts greater than or less than any amount that may be otherwise present in a plant that has not been treated with the presently disclosed composition. If the agriculturally acceptable product of the present disclosure is applied to a plant that produces tannins, the tannins included in the agriculturally acceptable product may be different from any tannin produced by that plant, or alternatively may be the same type of tannin produced by that plant.

The agriculturally-acceptable product of the present disclosure may include one or more other agriculturally acceptable items, such as emulsifiers, dispersants, surfactants and/or humectants, inert components, thickeners, bactericides, resistance inductors, biopesticides, fungicides, fertilizers, hormones, and the like.

Examples of the emulsifiers that may be used with the agriculturally acceptable formulation include, but are not limited to, emulsifiers known in the agricultural art. Examples include anionic or non-ionic emulsifiers, complementary emulsifiers, co-emulsifiers, and mixtures thereof. Examples of anionic emulsifiers include but are not limited to alkyl phosphate esters, isopropylamine dodecylbenzenesulfonate, and calcium dodecylbenzenesulfonate. Examples of non-ionic emulsifiers include but are not limited to castor oil ethoxylates, poly aryl ethoxylate, and aromatic ethoxylates. Examples of complementary and co-emulsifiers include but are not limited to epoxidized soybean oil. Mixtures of emulsifiers may also be used. The amount of emulsifier present is not particularly limited. In some exemplary embodiments, the amount of emulsifier in the formulation, or the total amount of a mixture of emulsifiers in the formulation, may be between 1% and 15% (by volume). In yet further exemplary embodiments, the amount of emulsifier in the formulation, or the total amount of a mixture of emulsifiers in the formulation, may be greater than, for example, 1%, 2%, 3%, 4%, 5%, 6%, 7%, 8%, 9%, 10%, 11%, 12%, 13%, or 14%. In other exemplary embodiments, the amount of emulsifier in the formulation, or the total amount of a mixture of emulsifiers in the formulation, may be less than, for example, 2%, 3%, 4%, 5%, 6%, 7%, 8%, 9%, 10%, 11%, 12%, 13%, 14%, or 15%. In some exemplary embodiments, the amount of emulsifier in the formulation, or the total amount of a mixture of emulsifiers in the formulation, may be between 5% and 15%, 5% and 10%, 7% and 15%, 7% and 10%, or 10% and 15%. In other exemplary embodiments, the amount of emulsifier in the formulation may be between 1% and 55%. In such embodiments, the total amount of emulsifier or a mixture of emulsifiers in the formulation may be greater than, for example, 15%, 20%, 25%, 30%, 35%, 40%, 45%, or 50%; and less than, for example, 50%, 45%, 40%, 35%, 30%, 25%, 20%, 15%, 10%, or 5%.

Examples of the dispersants that may be used with the agriculturally acceptable formulation include, but are not limited to, sodium lignosulfonate, alpha-olefin sulfonates, alky lauryl sulfonates, lignin sulfonates, block copolymers, ethylene oxide/propylene oxide copolymers, polyoxyethylene-polyoxypropylene copolymers, tridecyl alcohol ethoxylates, and polyacrylates. Mixtures of dispersants may also be used. The amount of dispersant present is not particularly limited. In some exemplary embodiments, the amount of a dispersant in the formulation, or the total amount of a mixture of dispersants in the formulation, may be between 1% and 70% (by volume). In yet further exemplary embodiments, the amount of a dispersant in the formulation, or the total amount of a mixture of dispersants in the formulation, may be greater than, for example, 2%, 5%, 10%, 15%, 20%, 25%, 30%, 35%, 40%, 45%, 50%, 55%, 60%, or 65%. In other exemplary embodiments, the amount of a dispersant in the formulation, or the total amount of a mixture of dispersants in the formulation, may be less than, for example, 2%, 5%, 10%, 15%, 20%, 25%, 30%, 35%, 40%, 45%, 50%, 55%, 60%, or 65%. In some exemplary embodiments, the amount of a dispersant in the formulation, or the total amount of a mixture of dispersants in the formulation, may be between 5% and 20%, 15% and 30%, 25% and 40%, 40% and 55% or 55% and 70%.

Examples of the surfactants and/or humectants that may be used with the agriculturally acceptable formulation include, but are not limited to, surfactants known in the art, such as naphthalene sulfonate, dioctyl sodium sulfosuccinate, glycerin, polyglycerin, castor oil and/or soybean oil, dodecylbenzene sodium sulfonate, sodium lauryl sulfate, and other phosphates; and also include ionic, nonionic, amphoteric, and neutral surfactants such as sodium lauryl sulfate, sodium dodecyl sulfate, sodium dodecyl sulfonate, sorbitols, benzenesulfonic acid and its alkylated derivatives C₁₀-C₁₆, castor oils and their derivatives, propylene oxides, polyethylene glycols, ethoxylated polyethylene glycols, amides. Mixtures of surfactants and/or humectants may also be used. The amount of surfactants and/or humectants present is not particularly limited. In some exemplary embodiments, the amount of a surfactant and/or humectant in the formulation, or the total amount of a mixture of surfactants and/or humectants in the formulation, may be between 1% and 70% (by volume). In yet further exemplary embodiments, the amount of a surfactant and/or humectant in the formulation, or the total amount of a mixture of surfactants and/or humectants in the formulation, may be greater than, for example, 2%, 5%, 10%, 15%, 20%, 25%, 30%, 35%, 40%, 45%, 50%, 55%, 60%, or 65%. In other exemplary embodiments, the amount of a surfactant and/or humectant in the formulation, or the total amount of a mixture of surfactants and/or humectants in the formulation, may be less than, for example, 2%, 5%, 10%, 15%, 20%, 25%, 30%, 35%, 40%, 45%, 50%, 55%, 60%, or 65%. In some exemplary embodiments, the amount of a surfactant and/or humectant in the formulation, or the total amount of a mixture of surfactants and/or humectants in the formulation, may be between 5% and 20%, 15% and 30%, 25% and 40%, 40% and 55% or 55% and 70%.

Examples of the inert components that may be used with the agriculturally acceptable formulation include, but are not limited to, celite, diatomaceous earth, bentonite, pyrophyllite, kaolin, montmorillonite, thenardite, attapulgite, dolomite, clay, cork, humic acids, and fulvic acids. Mixtures of inert components may also be used. The amount of inert components present is not particularly limited. In some exemplary embodiments, the amount of an inert component in the formulation, or the total amount of a mixture of inert components in the formulation, may be between 1% and 95% (by mass). In yet further exemplary embodiments, the amount of an inert component in the formulation, or the total amount of a mixture of inert components in the formulation, may be greater than, for example, 2%, 5%, 10%, 15%, 20%, 25%, 30%, 35%, 40%, 45%, 50%, 55%, 60%, 65%, 70%, 75%, 80%, 85% or 90%. In other exemplary embodiments, the amount of an inert component in the formulation, or the total amount of a mixture of inert components in the formulation, may be less than, for example, 2%, 5%, 10%, 15%, 20%, 25%, 30%, 35%, 40%, 45%, 50%, 55%, 60%, 65%, 70%, 75%, 80%, 85% or 90%. In some exemplary embodiments, the amount of an inert component in the formulation, or the total amount of a mixture of inert components in the formulation, may be between 5% and 20%, 15% and 30%, 25% and 40%, 40% and 55%, 55% and 70%, 70% and 85%, or 80% and 95%.

Examples of the thickeners that may be used with the agriculturally acceptable formulation include, but are not limited to, xanthan gum, guar gum, maltodextrins, dextrins, lecithin, and polysaccharides. Mixtures of thickeners may also be used. The amount of thickeners present is not particularly limited. In some exemplary embodiments, the amount of a thickener in the formulation, or the total amount of a mixture of thickeners in the formulation, may be between 1% and 70% (by mass). In yet further exemplary embodiments, the amount of a thickener in the formulation, or the total amount of a mixture of thickeners in the formulation, may be greater than, for example, 2%, 5%, 10%, 15%, 20%, 25%, 30%, 35%, 40%, 45%, 50%, 55%, 60%, or 65%. In other exemplary embodiments, the amount of a thickener in the formulation, or the total amount of a mixture of thickeners in the formulation, may be less than, for example, 2%, 5%, 10%, 15%, 20%, 25%, 30%, 35%, 40%, 45%, 50%, 55%, 60%, or 65%. In some exemplary embodiments, the amount of a thickener in the formulation, or the total amount of a mixture of thickeners in the formulation, may be between 5% and 20%, 15% and 30%, 25% and 40%, 40% and 55% or 55% and 70%.

Examples of the bactericides that may be used with the agriculturally acceptable formulation include, but are not limited to, gentamicin, streptomycin, oxytetracycline, kasugamicin, kanamycin, TCMTB ((benzothiazol-2-ylthio) methyl thiocyanate), MTC (methylene bis (thiocyanate)), blasticidin, natamicyn, and mixtures thereof. Additional examples of bactericides that may be used include other aminoglycocides and other tetracyclines. The amount of bactericides present is not particularly limited. In some exemplary embodiments, the amount of a bactericide in the formulation, or the total amount of a mixture of bactericides in the formulation, may be between 5% and 60% (by mass). In yet further exemplary embodiments, the amount of a bactericide in the formulation, or the total amount of a mixture of bactericides in the formulation, may be greater than, for example, 7%, 10%, 15%, 20%, 25%, 30%, 35%, 40%, 45%, 50%, or 55%. In other exemplary embodiments, the amount of a thickener in the formulation, or the total amount of a mixture of thickeners in the formulation, may be less than, for example, 7%, 10%, 15%, 20%, 25%, 30%, 35%, 40%, 45%, 50%, or 55%. In some exemplary embodiments, the amount of a thickener in the formulation, or the total amount of a mixture of thickeners in the formulation, may be between 5% and 20%, 15% and 30%, 25% and 40%, 40% and 55% or 50% and 60%.

Examples of the resistance inductors that may be used with the agriculturally acceptable formulation include, but are not limited to, fluoxastrobin, metominostrobin, hymexazol, acibenzolar-s-metil, mandestrobin, coumoxystrobin, flufenoxystrobin, mandestrobin, azoxystrobin, enoxastrobin, picoxystrobin, pyraoxystrobin, pyraclostrobin, pyrametostrobin, triclopyricarb, famoxadone, dimoxystrobin, fenaminstrobin, orysastrobin, kresoxim-methyl, trifloxystrobin, laminarin, salicylic acid, jasmonic acid, acibenzolar-S-methyl, chitosan, seaweed extracts, phosphonates, wheat and soybean extracts, ascorbic acid, glutathione, and mixtures thereof. The amount of resistance inductors present is not particularly limited. In some exemplary embodiments, the amount of a resistance inductor in the formulation, or the total amount of a mixture of resistance inductors in the formulation, may be between 5% and 50% (by volume). In yet further exemplary embodiments, the amount of a resistance inductor in the formulation, or the total amount of a mixture of resistance inductors in the formulation, may be greater than, for example, 7%, 10%, 15%, 20%, 25%, 30%, 35%, 40%, or 45%. In other exemplary embodiments, the amount of a resistance inductor in the formulation, or the total amount of a mixture of resistance inductors in the formulation, may be less than, for example, 7%, 10%, 15%, 20%, 25%, 30%, 35%, 40%, or 45%. In some exemplary embodiments, the amount of a resistance inductor in the formulation, or the total amount of a mixture of resistance inductors in the formulation, may be between 5% and 15%, 15% and 25%, 25% and 35%, 35% and 45% or 40% and 50%.

Examples of the biopesticides that may be used with the agriculturally acceptable formulation include, but are not limited to, Bacillus subtillis, Bacillus amyloliquefasciens, carboxilic acids, oxolinic acids, Bacillus micoides, Trichoderma atriviride, quitosan, and mixtures thereof. The amount of biopesticides present is not particularly limited. In some exemplary embodiments, the amount of a biopesticide in the formulation, or the total amount of a mixture of biopesticides in the formulation, may be between 10% and 50% (by volume). In yet further exemplary embodiments, the amount of a biopesticide in the formulation, or the total amount of a mixture of biopesticides in the formulation, may be greater than, for example, 12%, 15%, 20%, 25%, 30%, 35%, 40%, or 45%. In other exemplary embodiments, the amount of a biopesticide in the formulation, or the total amount of a mixture of biopesticides in the formulation, may be less than, for example, 12%, 10%, 15%, 20%, 25%, 30%, 35%, 40%, or 45%. In some exemplary embodiments, the amount of a biopesticide in the formulation, or the total amount of a mixture of biopesticides in the formulation, may be between 10% and 15%, 15% and 25%, 25% and 35%, 35% and 45% or 40% and 50%.

Examples of fungicides that may be used with the agriculturally acceptable formulation include, but are not limited to chlorothalonil, PCNB (pentachloronitrobenzene), maneb, coppers, ziram, mancozeb, metalaxyl, benomyl, iprodione, tifluzamide, dimetomorph, myclobutanil, pentiopirad, fludioxonil, cyazofamid, thiabendazole, propamocarb, fenhexamid, boscalid, fluopicolide, extract of Reynoutria sachalinensis, triflumizole, iprodiona, propamocarb, prochloraz, tiabendazole, epoxiconazole, metalaxil, cymoxanil, picarbutrazox, and mixtures thereof. The amount of fungicides present is not particularly limited. In some exemplary embodiments, the amount of a fungicide in the formulation, or the total amount of a mixture of fungicides in the formulation, may be between 5% and 75% (by volume). In yet further exemplary embodiments, the amount of a fungicide in the formulation, or the total amount of a mixture of fungicides in the formulation, may be greater than, for example, 7%, 10%, 15%, 20%, 25%, 30%, 35%, 40%, 45%, 50%, 55%, 60%, 65%, or 70%. In other exemplary embodiments, the amount of a fungicide in the formulation, or the total amount of a mixture of fungicides in the formulation, may be less than, for example, 7%, 10%, 15%, 20%, 25%, 30%, 35%, 40%, 45%, 50%, 55%, 60%, 65%, or 70%. In some exemplary embodiments, the amount of a fungicide in the formulation, or the total amount of a mixture of fungicides in the formulation, may be between 5% and 20%, 15% and 30%, 25% and 40%, 40% and 55%, 55% and 70%, or 60% and 75%.

Examples of fertilizers that may be used with the agriculturally acceptable formulation include both foliage and soil fertilizers and include, but are not limited to, magnesium, boron, zinc, nitrogen, manganese, calcium, aluminum, chelates, iron, molybdenum, potassium, cobalt, copper, phosphite, sulfur, and amino acids. The amount of fertilizers present is not particularly limited. In some exemplary embodiments, the amount of a fertilizer in the formulation, or the total amount of a mixture of fertilizers in the formulation, may be between 0.0001% and 60% (by mass). In yet further exemplary embodiments, the amount of a fertilizer in the formulation, or the total amount of a mixture of fertilizers in the formulation, may be greater than, for example, 0.0005%, 0.001%, 0.005%, 0.01%, 0.05%, 0.1%, 0.5%, 1%, 5%, 15%, 25%, 35%, 45%, or 55%. In yet further exemplary embodiments, the amount of a fertilizer in the formulation, or the total amount of a mixture of fertilizers in the formulation, may be less than, for example, 0.0005%, 0.001%, 0.005%, 0.01%, 0.05%, 0.1%, 0.5%, 1%, 5%, 15%, 25%, 35%, 45%, or 55%. In some exemplary embodiments, the amount of a fertilizer in the formulation, or the total amount of a mixture of fertilizers in the formulation, may be between 0.0001% and 0.001%, 0.01% and 0.1%, 0.1% and 1%, 1% and 10%, 5% and 25%, 15% and 30%, 25% and 50%, or 40% and 60%.

Examples of hormones that may be used with the agriculturally acceptable formulation include, but are not limited to plant hormones, cytokinins, gibberellins, ethylene, abscisic acid, and auxins. The amount of hormones present is not particularly limited. In some exemplary embodiments, the amount of a hormone in the formulation, or the total amount of a mixture of hormones in the formulation, may be between 0.0001% and 20% (by mass). In yet further exemplary embodiments, the amount of a hormone in the formulation, or the total amount of a mixture of hormones in the formulation, may be greater than, for example, 0.0005%, 0.001%, 0.005%, 0.01%, 0.05%, 0.1%, 0.5%, 1%, 2.5%, 5%, 7.5%, 10%, 12.5%, 15%, or 17.5%. In yet further exemplary embodiments, the amount of a hormone in the formulation, or the total amount of a mixture of hormones in the formulation, may be less than, for example, 0.0005%, 0.001%, 0.005%, 0.01%, 0.05%, 0.1%, 0.5%, 1%, 2.5%, 5%, 7.5%, 10%, 12.5%, 15%, or 17.5%. In some exemplary embodiments, the amount of a hormone in the formulation, or the total amount of a mixture of hormones in the formulation, may be between 0.0001% and 0.001%, 0.01% and 0.1%, 0.1% and 1%, 1% and 5%, 5% and 10%, 10% and 15%, or 15% and 20%.

Examples of nematicides that may be used with the agriculturally acceptable formulation include, but are not limited to, cadusafos, dichlofenthion, ethoprophos, fenamiphos, fluensulfone, fosthiazate, fosthietan, imicyafos, isamidofos, isazofos, methyl bromide, methyl isothiocyanate, oxamyl, sodium azide, and thiaxazafen. In some exemplary embodiments, the amount of a nematicide in the formulation, or the total amount of a mixture of nematicides in the formulation, may be between 5% and 75% (by volume). In yet further exemplary embodiments, the amount of a nematicide in the formulation, or the total amount of a mixture of nematicides in the formulation, may be greater than, for example, 7%, 10%, 15%, 20%, 25%, 30%, 35%, 40%, 45%, 50%, 55%, 60%, 65%, or 70%. In other exemplary embodiments, the amount of a nematicide in the formulation, or the total amount of a mixture of nematicides in the formulation, may be less than, for example, 7%, 10%, 15%, 20%, 25%, 30%, 35%, 40%, 45%, 50%, 55%, 60%, 65%, or 70%. In some exemplary embodiments, the amount of a nematicide in the formulation, or the total amount of a mixture of nematicides in the formulation, may be between 5% and 20%, 15% and 30%, 25% and 40%, 40% and 55%, 55% and 70%, or 60% and 75%.

Examples of other agriculturally acceptable materials that may be used with the agriculturally acceptable formulation include, but are not limited to, copper sulfate, copper oxychloride, copper hydroxide, cuprocalcic sulfate, sulfur in all variants, copper gluconate, copper octanoate, tribasic copper sulfate, calcium chloride, phosphoric acid, zinc oxide, phosphite, and mixtures thereof. The amount of other agriculturally acceptable materials present is not particularly limited. In some exemplary embodiments, the amount of another agriculturally acceptable material in the formulation, or the total amount of a mixture of other agriculturally acceptable materials in the formulation, may be between 0.05% and 70% (by mass). In yet further exemplary embodiments, the amount of another agriculturally acceptable material in the formulation, or the total amount of a mixture of other agriculturally acceptable materials in the formulation, may be greater than, for example, 0.1%, 0.5%, 1%, 5%, 10%, 15%, 20%, 25%, 30%, 35%, 40%, 45%, 50%, 55%, 60%, or 65%. In other exemplary embodiments, the amount of another agriculturally acceptable material in the formulation, or the total amount of a mixture of other agriculturally acceptable materials in the formulation, may be less than, for example, 0.1%, 0.5%, 1%, 5%, 10%, 15%, 20%, 25%, 30%, 35%, 40%, 45%, 50%, 55%, 60%, or 65%. In some exemplary embodiments, the amount of another agriculturally acceptable material in the formulation, or the total amount of a mixture of other agriculturally acceptable materials in the formulation, may be between 0.05% and 0.1%, 0.1% and 0.5%, 0.5% and 1%, 1% and 5%, 5% and 15%, 15% and 25%, 25% and 40%, 40% and 50%, 50% and 60%, or 60% and 70%.

The phenoxyethanol and/or the agriculturally acceptable product of the present disclosure can be, for example, deposited in and mixed with a reasonable amount of water to be sprinkled in very thin droplets of water “to the point of dripping” via appropriate equipment to the crop that it is intended to protect, in which pathogen damage may be present and would otherwise continue to harm the plants. The amount of agriculturally acceptable product of the present disclosure may be, for example, 100-1,000 liters of product per hectare when applied aerially in a greenhouse or other enclosure; 300-1,000 liters of product per hectare when applied to plants via nozzles; 1,000-2,000 liters of product per hectare when applied by a jetstream sprayer; 100-400 liters of product per hectare when applied by a back pack sprayer; 10-50 liters per hectare when applied via drone; 400-600 liters of product per hectare when used on plants such as tomatoes, peppers, onions, and the like. The amount of product used is not particularly limited, however, and any amount may be used so long as it provides for the anti-pathogenic effects disclosed herein.

The agriculturally acceptable formulation of the present disclosure may be applied to plants in need of treatment or prevention of the pathogens discussed herein. For example, the presently disclosed formulation may be administered to plants either before or after they exhibit symptoms of infection by bacteria or fungi, and may be administered either before or after showing signs of nematode infestation.

The method by which the agriculturally acceptable formulation may be administered to plants is not particularly restricted. Examples include the application of the agriculturally acceptable formulation by airplane or sprayer (such as an airblast sprayer, a manual sprayer, or a mechanical sprayer). The agriculturally acceptable formulation may also be applied by a drencher, in which the agriculturally acceptable formulation is administered to the soil. In addition, the agriculturally acceptable formulation may be applied to plants via irrigation systems. In certain instances, the agriculturally acceptable formulation may also be injected into a plant.

The agriculturally acceptable formulation may be applied to a plant, a plant's foliage, or may be applied to the soil. For example, the agriculturally acceptable formulation may be applied to the foliage, stem, canopy, trunk, roots, shoots, twigs, and/or flowers of a plant. The agriculturally acceptable formulation may also be applied to seeds and to a plant's rhizomes. The agriculturally acceptable formulation may be applied to seedlings.

If applied to a plant or a plant's foliage, the agriculturally acceptable formulation may be administered in an amount so as to provide for the bactericidal, fungicidal, or nematodal effect of the present disclosure. For example, the agriculturally acceptable formulation may be applied so as to administer the amount of phenoxyethanol necessary to provide for anti-pathogenic effects of the present invention. Such amounts may be determined based on the concentration of phenoxyethanol present in the agriculturally acceptable formulation. The agriculturally acceptable formulation may be administered to plants in intervals of, for example, 1-21 days, preferably intervals of 2-14 days, and also preferably intervals of 3-7 days. However, the amounts and intervals are not limited thereto and may be determined based on the agriculturally acceptable formulation. The agriculturally acceptable formulation can be administered in the nursery stage, the seedling stage, the transplant stage, the vegetative stage, pre-bloom, during full-bloom, post-bloom, and during fruit set. The agriculturally acceptable formulation can also be administered during a plant's dormancy.

The agriculturally acceptable formulation of the present disclosure may be made by mixing together the materials listed above. The manner in which the materials are mixed is not particularly limiting. The phenoxyethanol may be added to a predetermined amount of water and/or the other materials noted herein, and, if necessary, water conditioner.

The agriculturally acceptable formulation is a bactericidal, fungicidal, and nematicidal formulation that can be used in a wide variety of plants and plant species that have great economic importance. These include, but are not limited to, vegetables crops such as artichoke, asparagus, beet, beetroot, bell pepper, broccoli, brussels sprout, cabbage, carrot, cauliflower, celery, sweet corn, cucumber, eggplant, beans, green bean, onion, green onion, leek, lettuce, pea, pepper, potato, pumpkin, radish, spring onion, squash, sweet potato, tomato, zucchini, and mushrooms; as well as cereal crops such as wheat, oats, corn, rice, barley, sorghum, triticale, quinoa, and the like; as well as fruit crops such as avocado, apple, pears, peaches, plum, banana, prune, citrus, lemons, oranges, pomegranate, papaya, mango, lychee, rambutan, strawberry, cranberry, blackberry, raspberry; as well as other crops such as nuts, pastures, sugar cane, and the like.

The agriculturally acceptable formulation may also be used in the treatment of nurseries and seedbeds, as well as in ornamental plants, such as flowers that include chrysanthemums, daisies, roses, begonias, gladiolas, geraniums, gardenias, and carnations. The agriculturally acceptable formulation is also beneficial to protect shade trees, forest trees, and annual and bi-annual crops from the pathogens described herein.

As examples, a preparation of the agriculturally acceptable formulation is effective to control generally gram-negative species and gram-positive species, such Erwinia species, Pseudomonas species, Xanthomonas species, Pectobacterium species, Enterobacter species, Pantoea species, Streptomyces species, Phytoplasmas species, Corynebacterium species, Ralstonia species, Clavibacter species, and Agrobacterium species. Specifically bacteria that belong to the following species: Acetobacter aceti, Acetobacter pasteurianus, Acidovorax anthurii, Acidovorax avenae, Acidovorax avenae subsp. avenae, Acidovorax avenae subsp. cattleyae, Acidovorax avenae subsp. citrulli, Acidovorax konjaci, Acidovorax valerianellae, Acidovorax cattleyae, Acidovorax citrulli, Acidovorax oryzae Rhizobium, Rhizobium larrymoorei, Rhizobium radiobacter, Rhizobium rhizogenes, Rhizobium rubi, Rhizobium viti. Arthrobacter sp. Arthrobacter ilicis, Bacillus sp., Bacillus megaterium, Bacillus megaterium pv. cerealis, Bacillus pumilus, Brenneria alni, Brenneria nigrifluens, Brenneria quercina, Brenneria rubrifaciens, Brenneria salicis, Brenneeria quercina pv. quercina, Brenneeria quercina pv. lupinicola, Burkholderia andropogonis, Burkholderia caryophylli, Burkholderia cepacia, Burkholderia gladioli, Burkholderia gladioli pv. agaricicola, Burkholderia gladioli pv alliicola, Burkholderia gladioli pv. Gladioli, Burkholderia glumae, Burkholderia plantarii, Ralstonia solanacearum, Candidatus liberibacter, Candidatus liberibacter africanis, Candidatus liberibacter africanis subsp. capensis, Candidatus liberibacter americanus, Candidatus liberibacter asiaticus, Candidatus phlomobacter, Candidatus phlomobacter fragariae, Candidatus phytoplasma, Candidatus phytoplasma allocasuarinae, Candidatus phytoplasma americanum, Candidatus phytoplasma asteris, Candidatus phytoplasma aurantifolia, Candidatus phytoplasma australasia, Candidatus phytoplasma australiense, Candidatus phytoplasma brasiliense, Candidatus phytoplasma caricae, Candidatus phytoplasma castaniae, Candidatus phytoplasma cynodontis, Candidatus phytoplasma fragariae, Candidatus phytoplasma fraxini, Candidatus phytoplasma graminis, Candidatus phytoplasma japonicum, Candidatus phytoplasma lycopersici, Candidatus phytoplasma mali, Candidatus phytoplasma oryzae, Candidatus phytoplasma phoenicium, Candidatus phytoplasma pini, Candidatus phytoplasma prunorum, Candidatus phytoplasma pyri, Candidatus phytoplasma rhamni, Candidatus phytoplasma spartii, Candidatus phytoplasma trifolii, Candidatus phytoplasma ulmi, Candidatus phytoplasma ziziphi, Candidatus phytoplasma omanense, Candidatus phytoplasma tamaricis, Candidatus liberibacter psyllaurous, Candidatus liberibacter solanacearum, Clavibacter sp, Rathayibacter iranicus, Clavibacter michiganensis, Clavibacter michiganensis subsp. insidiosus, Clavibacter michiganensis subsp. michiganensis, Clavibacter michiganensis subsp. nebraskensis, Clavibacter michiganensis subsp. sepedonicus, Clavibacter michiganensis subsp. tessellarium, Clostridium sp. Clostridium puniceum. Corynebacterium sp. Curtobacterium sp., Curtobacterium flaccumfaciens pv. betae, Curtobacterium flaccumfaciens pv. flaccumfaciens, Curtobacterium flaccumfaciens pv. ilicis, Curtobacterium flaccumfaciens pv. oortii, Curtobacterium flaccumfaciens pv. poinsettiae, Dickeya sp., Dickeya chrysanthemi, Dickeya chrysanthemi pv. chrysanthemi, Dickeya chrysanthemi pv. parthenii, Dickeya dadantii, Dickeya diantbicola, Dickeya dieffenbachiae, Dickeya paradisiaca, Dickeya zeae, Enterobacter sp. Enterobacter cancerogenus, Enterobacter cloacae, Enterobacter cloacae subsp dissolvens, Enterobacter nimipressuralis, Enterobacter pyrinus, Erwinia sp., Erwinia amylovora, Erwinia mallotivora, Erwinia papayae, Erwinia persicina, Erwinia psidii, Erwinia pyrifoliae, Erwinia rhapontici, Erwinia tracheiphila, Ewingella sp., Ewingella americana, Gluconobacter sp. G. oxydans, Herbaspirillum sp., Herbaspirillum rubrisubalbicans, Janthinobacterium sp. J. agaricidamnosum, Leifsonia sp. Leifsonia cynodontis, Leifsonia xyli, Leifsonia xyli subsp. cynodontis, Leifsonia xyli subsp xyli, Nocardia sp., Nocardia vaccinii, Pantoea sp., Pantoea agglomerans, Pantoea agglomerans pv. gypsophilae, Pantoea agglomerans pv. millettiae, Pantoea ananatis, Pantoea ananatis pv. ananatis, Pantoea ananatis pv. uredova, Pantoea stewartii, Pantoea stewartii subsp. indologenes, Pantoea stewartii subsp. stewartii, Pectobacterium sp., Pectobacterium atrosepticum, Pectobacterium betavasculorum, Pectobacterium cacticida, Pectobacterium carotovorum, Pectobacterium carotovorum subsp. carotovorum, Pectobacterium carotovorum subsp. odoriferum, Pectobacterium cypripedii, Pectobacterium wasabiae, Pseudomonas sp., Pseudomonas agarici, Pseudomonas amygdali, Pseudomonas asplenii, Pseudomonas avellanae, Pseudomonas beteli, Pseudomonas cannabina, Pseudomonas caricapapayae, Pseudomonas cichorii, Pseudomonas cissicola, Pseudomonas corrugata, Pseudomonas costantinii, Pseudomonas ficuserectae, Pseudomonas flectens, Pseudomonas fuscovaginae, Pseudomonas hibiscicola, Pseudomonas marginalis, Pseudomonas matginalis pv. alfalfae, Pseudomonas marginalis pv. marginalis Pseudomonas marginalis pv. pastinacae, Pseudomonas mediterranea, Pseudomonas meliae Pseudomonas palleroniana, Pseudomonas salomonii, Pseudomonas savastanoi, Pseudomonas savastanoi pv. Pseudomonas savastanoi pv. glycinea, Pseudomonas savastanoi pv. nerii, Pseudomonas savastanoi pv. phaseolitica, Pseudomonas savastanoi pv. retacarpa, Pseudomonas savastanoi pv. savastanoi, Pseudomonas syringae, Pseudomonas syringae pv. aceris, Pseudomonas syringae pv. actinidiae, Pseudomonas syringae pv. aesculi, Pseudomonas syringae pv. alisalensis, Pseudomonas syringae pv. antirrhini, Pseudomonas syringae pv. apii, Pseudomonas syringae pv. aptata, Pseudomonas syringae pv. atrofaciens, Pseudomonas syringae pv. atropurpura, Pseudomonas avellanae, Pseudomonas syringae pv. avvi, Pseudomonas syringae pv. berberidis, Pseudomonas cannabina, Pseudomonas syringae pv. broussonetiae, Pseudomonas syringae pv. castaneae, Pseudomonas syringae pv cerasicola, Pseudomonas syringae pv. ciccaronei, Pseudomonas syringae pv coriandricola, Pseudomonas syringae pv. coronafaciens, Pseudomonas syringae pv. coryli, Pseudomonas syringae pv. cunninghamiae, Pseudomonas syringae pv. daphniphylli, Pseudomonas syringae pv. delphinii, Pseudomonas syringae pv. dendropanacis, Pseudomonas syringae pv. disoxyli, Pseudomonas syringae pv. eriobotryae, Pseudomonas syringae pv. garcae, Pseudomonas sevastanoi pv. glycineae, Pseudomonas syringae pv. helianthi, Pseudomonas syringae pv. hibisci, Pseudomonas syringae pv. syringae, Pseudomonas syringae pv. lachrymans, Pseudomonas syringae pv lapsa, Pseudomonas syringae pv. maculicola, Pseudomonas syringae pv. mellea, Pseudomonas syringae pv. mori, Pseudomonas syringae pv. morsprunorum, Pseudomonas syringae pv. myricae, Pseudomonas syringae pv. oryzae, Pseudomonas syringae pv. papulans, Pseudomonas syringae pv. passiflorae, Pseudomonas syringae pv. persicae, Pseudomonas sevastanoi pv. phaseolicola, Pseudomonas syringae pv. philadelphi, Pseudomonas syringae pv. photiniae, Pseudomonas syringae pv. pisi, Pseudomonas syringae pv. porri, Pseudomonas syringae pv. primulae, Pseudomonas syringae pv. rhaphiolepidis, Pseudomonas syringae pv. ribicola, Pseudomonas syringae pv. sesami, Pseudomonas syringae pv. solidagae, Pseudomonas syringae pv. spinaceae, Pseudomonas syringae pv. striafaciens, Pseudomonas syringae pv. syringae, Pseudomonas syringae pv. tabaci, Pseudomonas syringae pv. tagetis, Pseudomonas syringae pv. theae, Pseudomonas syringae pv. tomato, Pseudomonas syringae pv. ulmi, Pseudomonas syringae pv. viburni, Pseudomonas syringae pv. zizaniae, Pseudomonas syringae pv., Ralstonia solanacearum, Ralstonia syzygii, Rathayibacter iranicus, Rathayibacter rathayi, Rathayibacter toxicus, Rathayibacter tritici, Rhizobacter dauci, Rhizobium larrymoorei, Rhizobium radiobacter, Rhizobium rhizogenes, Rhizobium rubi, Rhizobium vitis, Rhodococcus fascians, Samsonia erythrinae, Serratia marcescens, Serratia proteamaculans, Sphingomonas melonis, Sphingomonas suberifasciens, Spriroplasma citri, Spriroplasma kunkelii, Spriroplasma phoeniceum, Streptomyces acidiscabies, Streptomyces albidoflavus, Streptomyces candidus, Streptomyces caviscabies, Streptomyces collinus, Streptomyces europaeiscabiei, Streptomyces intermedius, Streptomyces ipomocae, Streptomyces luridiscabiei, Streptomyces niveiscabiei, Streptomyces puniciscabiei, Streptomyces reticuliscabei, Streptomyces scabiei, Streptomyces setonii, Streptomyces steliiscabiei, Streptomyces turgidiscabieis, Streptomyces wedmorensis, Xanthomonas albilineans, Xanthomonas alfalfae, Xanthomonas alfalfae subsp. alfalfae, Xanthomonas alfalfae subsp. citrumelonis, Xanthomonas arboricola, Xanthomonas arboricola pv. celebensis, Xanthomonas arboricola pv. corylina, Xanthomonas arboricola pv. fragariae, Xanthomonas arboricola pv. juglandis, Xanthomonas anoxopodis pv. poinsettiicola, Xanthomonas arboricola pv. populi, Xanthomonas arboricola pv. pruni, Xanthomonas anoxopodis, Xanthomonas fuscans subsp. aurantifolii, Xanthomonas axanopodis pv. Xanthomonas axonopodis pv. axonopodis, Xanthomonas axonopodis pv. baubiniae, Xanthomonas axonopodis pv. begoniae, Xanthomonas axonopodis pv. betlicola, Xanthomonas axonopodis pv. biophyti, Xanthomonas axonopodis pv. cajani, Xanthomonas axonopodis pv. cassiae, Xanthomonas citri, Xanthomonas axonopodis pv. clitoriae, Xanthomonas axonopodis pv. coracanae, Xanthomonas axonopodis pv. cyamopsidis, Xanthomonas axonopodis pv. desmodii, Xanthomonas axonopodis pv. desmodiigangetici, Xanthomonas axonopodis pv. desmodiilaxiflori, Xanthomonas axonopodis pv. desmodiirotundifolii, Xanthomonas axonopodis pv. dieffenbachiae, Xanthomonas axonopodis pv. erythrinae, Xanthomonas axonopodis pv. fascicularis, Xanthomonas axonopodis pv. glycines, Xanthomonas axonopodis pv. khayae, Xanthomonas axonopodis pv. lespedezae, Xanthomonas axonopodis pv. maculifoliigardeniae, Xanthomonas citri subsp. malvacearum, Xanthomonas axonopodis pv. manibotis, Xanthomonas axonopodis pv. martyniicola, Xanthomonas axonopodis pv. melbusii, Xanthomonas axonopodis pv. nakataecorchori, Xanthomonas campestris pv. passiflorae, Xanthomonas axonopodis pv. patelii, Xanthomonas axonopodis pv. pedalii, Xanthomonas axonopodis pv. phaseoli, Xanthomonas axonopodis pv. phyllanthi, Xanthomonas axonopodis pv. physalidicola, Xanthomonas axonopodis pv. poinsettiicola, Xanthomonas axonopodis pv. punicae, Xanthomonas axonopodis pv. rhynchosiae, Xanthomonas axonopodis pv. ricini, Xanthomonas axonopodis pv. sesbaniae, Xanthomonas axonopodis pv. tamarindi, Xanthomonas axonopodis pv. vasculorum, Xanthomonas vesicatoria, Xanthomonas axonopodis pv. vignaeradiatae, Xanthomonas axonopodis pv. vignicola, Xanthomonas axonopodis pv. vitians, Xanthomonas bromi, Xanthomonas campestris, Xanthomonas campestris pv. aberrans, Xanthomonas campestris pv. armoraciae, Xanthomonas campestris pv. barbareae, Xanthomonas campestris pv. campestris, Xanthomonas campestris pv. incanae, Xanthomonas campestris pv. plantaginis, Xanthomonas campestris pv. raphani, Xanthomonas campestris pv. alangii, Xanthomonas campestris pv. amaranthicola, Xanthomonas campestris pv. amorphophalli, Xanthomonas campestris pv. aracearum. Xanthomonas campestris pv. arecae, Xanthomonas campestris pv. argemones, Xanthomonas campestris pv. arracaciae, Xanthomonas campestris pv. asclepiadis, Xanthomonas campestris pv. azadirachteae, Xanthomonas campestris pv. badrii, Xanthomonas campestris pv. betae, Xanthomonas campestris pv. bilvae, Xanthomonas campestris pv. blepharidis, Xanthomonas campestris pv. boerbaaviae, Xanthomonas campestris pv. brunneivaginae, Xanthomonas campestris pv. cannabis, Xanthomonas campestris pv. cannae, Xanthomonas campestris pv. carissae, Xanthomonas campestris pv. centellae, Xanthomonas campestris pv. clerodendri, Xanthomonas campestris pv. convolvuli, Xanthomonas campestris pv. coriandri, Xanthomonas campestris pv. daturae, Xanthomonas campestris pv. durantae, Xanthomonas campestris pv. esculenti, Xanthomonas campestris pv. eucalypti, Xanthomonas campestris pv. euphorbiae, Xanthomonas campestris pv. fici, Xanthomonas campestris pv. guizotiae, Xanthomonas campestris pv. gummisudans, Xanthomonas campestris pv. heliotropii, Xanthomonas campestris pv. ionidii, Xanthomonas campestris pv. lantanae, Xanthomonas campestris pv. laureliae, Xanthomonas campestris pv. lawsoniae, Xanthomonas campestris pv. leeana, Xanthomonas campestris pv. leersiae, Xanthomonas campestris pv. malloti, Xanthomonas campestris pv. mangiferaeindicae, Xanthomonas campestris pv. merremiae, Xanthomonas campestris pv. mirabilis, Xanthomonas campestris pv. mori, Xanthomonas campestris pv. musacearum, Xanthomonas campestris pv. nigromaculans, Xanthomonas campestris pv. obscurae, Xanthomonas campestris pv. olitorii, Xanthomonas campestris pv. papavericola, Xanthomonas campestris pv. parthenii, Xanthomonas campestris pv. paulliniae, Xanthomonas campestris pv. pennamericanum, Xanthomonas campestris pv. phormiicola, Xanthomonas campestris pv. physalidis, Xanthomonas campestris pv. sesami, Xanthomonas campestris pv. spermacoces, Xanthomonas campestris syngonii, Xanthomonas campestris pv. tardicrescens, Xanthomonas campestris pv. thespesiae, Xanthomonas campestris pv. thirumalacharii, Xanthomonas campestris pv. tribuli, Xanthomonas campestris pv. trichodermae, Xanthomonas campestris pv. uppalii, Xanthomonas campestris pv. vernomiae, Xanthomonas campestris pv. viegasii, Xanthomonas campestris pv. viticola, Xanthomonas campestris pv. vitiscarnosae, Xanthomonas campestris pv. vitistrifoliae, Xanthomonas campestris pv. vitiswoodrowii, Xanthomonas campestris pv. zantedeschiae, Xanthomonas campestris pv. zingibericola, Xanthomonas campestris pv. zinniae, Xanthomonas cassavae, Xanthomonas citri subsp malvarearum, Xanthomonas codiaei, Xanthomonas curcubitae, Xanthomonas cynarae, Xanthomonas euvesicatoria, Xanthomonas fragariae, Xanthomonas fuscans, Xanthomonas fuscans subsp. aurantifolii, Xanthomonas fuscans subsp. fuscans, Xanthomonas gardneri, Xanthomonas hortorum pv. carotae, Xanthomonas hortorum pv. hederae, Xanthomonas hortorum pv. pelargonii, Xanthomonas hortorum pv. taraxaci, Xanthomonas hyacinthi, Xanthomonas melonis, Xanthomonas oryzae, Xanthomonas oryzae pv. oryzae, Xanthomonas oryzae pv. oryzicola, Xanthomonas perforans, Xanthomonas pisi, Xanthomonas populi, Xanthomonas sacchari, Xanthomonas theicola, Xanthomonas translucens, Xanthomonas translucens pv. arrhenatheri, Xanthomonas translucens pv. cerealis, Xanthomonas translucens pv. graminis, Xanthomonas translucens pv. phlei, Xanthomonas translucens pv. phleipratensis, Xanthomonas translucens pv. poae, Xanthomonas translucens pv. secalis, Xanthomonas translucens pv. translucens, Xanthomonas translucens pv. undulosa, Xanthomonas vasicola, Xanthomonas vasicola pv. holcicola, Xanthomonas vesicatoria, Xylella fastidiosa, Xanthomonas fastidiosa subsp. fastidiosa, Xanthomonas fastidiosa subsp. multiplex, Xylophilus ampelinus, Gibbsiella quercinecans, Pantoea citrea, Pantoea cypripedii, Pseudomonas cannabina, Pseudomonas cannabina pv. alisalensis, Pseudomonas cannabina pv. cannabina, Tatumella morbirosei, Tatumella ptyseos, Xanthomonas axonopodis pv. anacardii, Xanthomonas anoxopodis mangiferaeindicae, Xanthomonas axonopodis pv. spondiae, Xanthomonas dyei, Xanthomonas dyei pv. dysoxyli, Xanthomonas dyei pv. eucalypti, Xanthomonas dyei pv. laureliae, Xanthomonas translucen pv. pistaciae.

Other plants, such as Cotoneaster, Pyracantha, Stranvaesia, Fraxinus, Pyrus, Malus, Capsicum, Cydonia, Crataegus, and Soreus can benefit from the application of the presently disclosed agriculturally acceptable formulation. For example: the agriculturally acceptable formulation can also be used immediately in plants or trees of the following genera: Asparagus officinalis, Alocasia macrorhiza, Acoelorraphe wrightii, Aiphanes aculeata, Archontophoenix alexandrae, Areca catechu, Acer negundo, Acer saccharinum, Arbustus xalapensis, Acasia farmesiana, Alnus acuminata, Aloc barbadensis, Apuntia spp., Anthurium andraeanum, Apium graveolens, Avena sativa, Actinidia deliciosa, A. chinensis, A. erguta, Anacardium occidentale, Allium cepa, Allium schoenoprasum, Allium fistulosum, A. ascalonicum, Annona reticulata, Amelanchier alnifolia, A. canadensis, A. laevia, Aronia arbutifolia, A. melanocarpa, Aruncus sylvester, Allium sativum, Allium porrum, Apium gravolens, Arachis hypogaea, Annona squamosa, Annona muricata, Acalypha hispida, Arachis hypogaea, Allium schoeroprassum, Apium graveolens, Allium spp., Adianthum spp, Brassica oleracea, B. campestris, B. napus, Byrsonima crassifolia, Brassica oleracea, B. oleracea var. botrytis Brassica capitate, Begonia argenteo-guttata, Bidens pilosa, Boldoa purpurascens, Bixa orellana, Bucida buceras, Buddleia cordata, Brahea armata, Beta vulgaris, Bougainvillea spectabilis, Bombax emarginatum, Beaucamea recurvata, Bahuinia divaricata, Curcubita moschata, C. maxima, C. pepo, Cucumis melo, Cucumis sativus, Chrysophyllum cainito, Coco nucifera, Carica papaya, Citrus aurantifolia, Citrus limonum, Calocarpum mammosum, Citrus reticulata, Citrullus vulgaris, Citrus aurantium, Citrus sinensis, Crataegus mexicana, Casimiroa edulis, Cucumis sativus, Colocasia esculenta, Cajanus cajan, Chamadorea graminofilia, Caladium spp., Chlorophytum comosum, Chysanthemum sinense, Cordyline terminalis, Cycas spp., Crocus sativus, Cinnamomum canella wintereana, Castus ruber, Callistephus hortensis, Coriandrum sativum, Coleus blumei, Chysantellum americanum, Casuarina equisetifolia, Cedrela odorata, Ceiba pentandra, Callistemon lanceolatus, Cassia fistula, Magnolia sp., Cocos nucifera, Chrysalidocarpus, Cyca circinalis, Cyca revoluta, Cynara cardunculus, C. scolymus, Citrus paradisi, Citrus grandis, Cestrum nocturnus, Chaenomeles japonica, C. lagenaria, Cotoneaster acuminatus, C. Adpressus Bois, C. affinis, C. ambiguus, C. apiculatus, C. ascendens, C. bullatus, C. floribunda, C. buxifolius, C. buxifolius f. vellaea, C. commixtus, C. congestus, C. conspicuus, C. dammeri, C. dielsianus, C. divaricatus, C. elegans, C. floccosus, C. foveolatus, C. franchetti, C. frigidus, C. glabratus, C. glaucophyllus, C. harrysmithii, C. henryanus, C. hissarcus, C. ignavus, C. insignia, C. horizontalis, C. khasiensis, C. lacteus, C. laxiflorus, C. lucidus, C. melanocarpus, C. microphyllus, C. moupinensis, C. multiflorus, C. nanshan, C. nitens, C. obscurus, C. obtusus, C. pannosus, C. perpusillus, C. polyanthemus, C. postratus, C. racemiflorus, C. roseus, C. rotundifolius, C. rubens, C. salsifolius, C. siminsii, C. soongoricus, C. spendens, C. stemianus, C. tenuipes, C. tormentosus, C. veitchii, C. villosulus, C. wardii, C. watereri, C, zabelii, Cowania stanburiana, Crataegomespilus dardarii, Crataegus arnoldiana, C. crusgalli, C. douglassi, C. flavellata, C. mollis, C. monogyna, C. oxyacantha, C. pedicellata, C. phaenopyrum, C. punctata, C. succulenta, C. uniflora, Capsicum annuum, Citrus sp., Cydonia oblonga, C. sinensis, Carya illinoinensis, Cocos nucifera, Chenopodium ambrosoides, Chamaerops humilis, Chamaedorea elegans, Citrus paradisi-reticulata, Catleya spp., Carum carvi, Chrysalidocarpus lutescens, Curcuma longa, Ceratozania mexicana, Caryota urens, Coccothrinax readii, Chamaedorea tepejilote, Coffea arabica, Dryas sp., Dianthus caryophyllus, Dieffenbachia spp., Dracaena deremensis, Daucus carota, Delonix regia, Dioscorea spp, Dypsis decaryi, Dicon espinolosum, Dicon edule, Daucus carota, Dracaena marginata, Delonix regia, Eriobotrya japonica, Exochorda sp., Eryobotria japonica, Echeveria spp., Euphorbia pulcherrima, Enterolobium cyclocarpum, Erythrina crista-galli, Elaeis guineensislutences, Eryngium foetidum, Erythrina Americana, Fragaria X ananassa, F. virginiana, Ficus carica, Fraxinus uhdei, Ficus lirata, Fragaria vesca, Ficus benjamina, Ficus retusa, Foeniculum vulgare, Geum sp., G. herbaceum, G. barbadense, G. hirstiumlpomoes batatas, Gossypium hirsutum, Glycine max, Geranium sp., Gardenia jasminoides, Gladiolus communis, Gerbera jamesonii, Guazuma ulmifolia, Grevillea robusta, Howea fosteriana, Hyophorbe lagenicaulis, Hibiscus rosa-sinensis, Helianthus annuus, Hoffinannia ghiresbreghtii, Helychrysum bracteanum, Heteromeles arbutifolia, Holodiscus discolor, Hibiscus elatus, Hyptis suaveolens, Helianthus tuberosus, Hibiscus esculentus, Higrangea macrophylla, Hedychium coronarium, Ixora incarnata, Iris spp., Impatiens balsamina, Juglandis nigra, Juglans regia, Justicia pectoralis, Jacaranda mimosifolia, Kageneckia oblonga, Kerria japonica, Kalanchoe pinnata, Lactuca sativa, Lycopersicon esculentum, Licuala grandis, Licuala peltata, L. paludosa, L. orbicularis, Ligustrum japonicum, Livistona chinensis, Lippia sp., Lens culinaris, Liquidambar styracifiva, Lagerstroemia indica, Malpighia punicifolia, Mammea americano, Melicocea bijuga, Mangifera indicaAnanas comosus, Musa paradisiaca, Musa balsisiana, Myrciaria cauliflora, Malus domestica tomanthes tristaneae carpa Malus malus spp., Mespillus germanica, Morus alba, Manihot esculenta, Medicago sativa, Monstera spp., Murraya paniculata, Mysotis scorpioides, Mejorana hortensis, Mentha arvensis, Mentha nemorosa, Morus alba, Nepholepsis spp., Nasturtium officinale, Nerium oleander, Osteomeles anthyllidfolia, Oryza sativa, Olea europea, Ocimum basilicum, Ocimum santum, P. capuli, P. allehaniensis, P. avium, P. besseyi, Prunus armeniaca, P. salicina, P. simonii, P. spinosa, P. triloba, P. mexicana, P. ceracifera, P. dasycarpa, P. domestica, P. fremontii, P. ilicifolia, P. lusitanica, P. mume, P. nigra, Prunus persica, Pyracantha angustifolia, P. atalantioides, P. coccinea, P. crenulata, P. crenulata var. kansuensis, P. fortuneana, P. koidzummi, P. rogersiana, P. umbellata, Phaseolus vulgaris, Psidium cattleianum, Photinia deflexa, P. glabra, P. villona, Physocarpus sp. Protentilia sp., Prinsepia sp., Pyrus communis, Pisum sativum, Pistacia vera, Prunus avium, Pachyrhizus erosus, Phyllantus acidus, Philodendron spp., Polianthes tuberosa, Pilea rotundifolia, Portulaca pilosa, Parkinsonia aculeata, Phoenix roebelenii, Pilea microphylla, Pimpinella asisum, Piper auritum, Pluchea carolinensis, Populus tremuloides, Populus canadensis, Populus italica, Pithecellobium dulce, Prosopis juliflora, Plumeria rubra, Platanus mexicanus, Phoenix datilifera, Pritchardia pacifica, Phoenix roebelenii, Pandanus utilis, Pastinaca sativa, Persea americana, Pouteria campechiana, Psidium guajaba, Punica granatum, Passiflora laurifolia, Peraphyllum ramossissimum, Pachypodium lamerei, Phoenix canadiensis, Quercus laurina, Quercus mexicana, Quercus rubra, Quercus rugosa, Quercus virginiana, Raphiolepia indica, Rhodotypos scandens, Rosa blanda, R. multiflora, R. rubiginasa, R. rubrifolia, Rubus idaeos, Rheum rhabarbarum, Rumex acetosa, Ravenea rivularis, Rhapis excelsa, Roystonea regia, Rhoeo discolor, Rosmarinus officinalis, Rubus ulmifolius, Rosa spp, Rhoeo discolor, Raphanus sativus, Roystonea regia, Rhizophora mangle, Salycopersicum esculentum, Sorbaria sp., Sorbus americana, S. aria, S. aucuparia, S. mougeotii, S. occidentalis, S. tianshanica, Spiraea cantoniensis, S. densiflora, S. van houteii, Solanum meolongenaSechium edule, Spinacia olereasa, Scindapsus spp., Spathyphyllum wallisii, Schefflera actinophylla, Sedum morganiarum, Sorghum bicolor, Salix bonplandiana, Schinus molle, Schinus terebinthefolius, Salix chilensis, Salix babylonica, Syagrus romanzoffiana, Scheelea liebmannii, Sabal palmetto, Sabal minor, Scorzonera hispanica, Saccharum officinarum, Spondias dulcis, Solanum tuberosum, Sansevieria spp, Strelitzia reginae, Tebebuia rosea, Tebebuia donnell-smithiiTamarix gallica, Thrinax radiata, Tragopogon porrifolius, Thuja orientalis, Talinum palicunatum, Tithonia diversofilia, Theobroma cacao, Tripticum aestivum, Tamarindus indica, Terminalia catapa, Ulmus parviflora, Vitis vinifera, Valerianella locusta, Vaccinium myrtillus, Vicia faba, Veitchia merrilli, Vetiveria zizanioides, Veitchia merilli, Verbena domingensis, Weddelia rugosa tenuis, Xanthosoma sugittifollum, Zea mays, Zinnia elegans, Zebrina pendula, Zingonium spp., Zanthoxylum pistacifolium, Zingiber cassumunar, Zamia furfuracea.

Fungi that may be inhibited or prevented using the presently disclosed composition include fungi from genera such as Alternaria, Phytophthora, Colletotrichum, Fusarium, downy mildew, powdery mildew, rusts, and other important taxonomic groups. Also included are fungi from the phyla Ascomycota, Basidiomycota, and Oomycota, which include many species of phytopathogenic fungi that are of great relevance in agriculture, such as Fusarium spp., Colletotrichum spp., Botrytis cinerea, Sclerotinia sclerotiorum, Venturia inaequalis, Blumeria graminis (powdery mildew), Monilinia fructicola (brown rot), Phytophthora spp., Plasmopara viticola, Pythium spp., Phytophthora infestans, Plasmopara viticola, Phytophthora spp., Rhizoctonia solani, Puccinia spp. (causing rust), Uromyces spp., Tilletia spp. (partial smut), Ustilago maydis (corn smut), Sporisorium reilianum, Ganoderma spp. and Rhizoctonia solani. Accordingly, examples of fungi that may be inhibited or prevented include Alternaria sp., Armillaria sp., Aspergillus sp., Bipolaris sp., Botryosphaeria sp., Botrytis sp., Cercospora sp., Cladosporium sp., Colletotrichum sp., Curvularia sp., Cylindrocladium sp., Cytospora sp., Didymella sp., Didymium sp., Diplodia sp., Epicoccum sp., Erysiphe sp., Exserohilum sp., Fomitopsis sp., Fusarium sp., Gaeumannomyces sp., Ganoderma sp., Glomerella sp., Helminthosporium sp., Lasiodiplodia sp., Leveillula sp., Macrophomina sp., Magnaporthe sp., Marasmiellus sp., Monilinia sp., Mycosphaerella sp., Neofusicoccum sp., Neopestalotiopsis sp., Nigrospora sp., Oidium sp., Peronospora sp., Phellinus sp., Phlebiopsis sp., Phoma sp., Phomopsis sp., Phytophthora sp., Plasmopara sp., Podosphaera sp., Puccinia sp., Pseudocercospora sp., Pythium sp., Rhizoctonia sp., Sclerotinia sp., Sclerotium sp., Schizophyllum sp., Septoria sp., Thanatephorus sp., Thielaviopsis sp., Trichoderma sp., Ustilago sp., Venturia sp., and Verticillium sp.

Nematodes that may be killed or prevented from infecting a plant include, but are not limited to, Meloidogyne spp., Globodera spp., Heterodera spp., Pratylenchus spp., Radopholus similis, Tylenchulus semipenetrans, Ditylenchus spp., Bursaphelenchus xylophilus, Rotylenchulus reniformis, and Xiphinema spp.

The present disclosure should not be considered to be limited to the listed bacteria, fungi, and nematodes, and other bacteria, fungi, and nematodes may be treated or prevented using the presently disclosed agriculturally acceptable formulation. The present disclosure should also not be considered to be limited to the plants listed herein, as other suitable plants may be the subject of the application of the disclosed formulations.

Without wishing to be bound by theory, it is believed that the effectiveness of the present composition may be a result of phenoxyethanol preventing microorganisms from making copies of their DNA and RNA. However, the present disclosure is not limited to any particular mode of action of the phenoxyethanol.

### EXAMPLES

The Examples herein objectively show the bactericidal, fungicidal, and nematicidal effects of the presently disclosed agriculturally acceptable formula in different concentrations against some relevant bacteria, fungi, and nematodes, including those which attack plants of great economic importance. The results demonstrate significant effects on the inhibition of the growth, spreading, or killing of phytopathogenic bacteria, fungi, and nematodes.

For the relevant Examples, phytopathogenic strains and nematodes were isolated from different fruits and vegetable crops. A mixture for agricultural use was developed in accordance with the following descriptions.

The sensitivity of bacteria to a given formulation was evaluated in petri dishes using a poisoned food (amended media) method, using agar culture media mixed with the proper amount of the formulation. The amended media method is commonly used to evaluate antifungal effects against fungi, and the method was modified where necessary to test bacteria instead of fungi. In the method, the relevant formulation was incorporated into molten agar at a desired final concentration and mixed well. Then, the resulting medium was poured into petri dishes. After overnight pre-incubation, the petri dishes containing the medium were inoculated with the relevant bacteria. After further incubation under suitable conditions for the bacterial strain tested, the positive or negative growth in the control and sample plates was measured. Thus, in brief, this methodology used the agar as a vehicle for the product dose, and after solidification, a very high concentration of bacterial suspension, was inoculated, while leaving a control petri dish inoculated with the same bacterial suspension containing only agar without the formulation.

For bacterial trials, the cultured media described above was mixed with phenoxyethanol at concentrations of 100%, 90% (with 10% water by volume), 70% (with 30% water by volume), and 50% (with 50% water by volume). Each concentration was tested with the following doses: 1, 2, 3, 4, 5, 6, 7, and 8 ml/L. For Clavibacter sp., Pectobacterium sp., Pseudomonas sp., Ralstonia sp., and Xanthomonas sp., after the media was prepared, the bacterial suspension was applied to the surface of the media at a concentration of 1:10,000. For Erwinia species, a concentration of 1:1,000 was used. For each treatment, 100 μL of the bacterial suspension was evenly distributed across the surface of the media using sterilized glass beads. The plates were then incubated for 24-48 hours at 28° C.±1.0° C. A negative control was included, consisting of agar without the active ingredient (phenoxyethanol). The bacterial suspensions used had a count of >250 CFU per plate, and each treatment was performed in triplicate. After the incubation period, the treatments were considered 100% effective if no bacterial colonies were observed on the surface of the medium.

For fungal trials, the cultured media described above was mixed with phenoxyethanol at concentrations of 100%, 90% (with 10% water by volume), 70% (with 30% water by volume), and 50% (with 50% water by volume). Each concentration was tested with the following doses: 1, 2, 3, 4, 5, and 6 ml/L. Once the media was treated, fungal suspensions were applied to the surface at a concentration of 1:10,000 for Colletotrichum sp. and Fusarium sp., and ⅛ of an active fungal disc for Alternaria sp., Phytophthora sp., Botrytis sp., and Bipolaris sp. The plates were then incubated for seven days at 28° C.±1.0° C. For each fungal genus, a negative control was prepared using agar without active ingredients. After the incubation period, the fungal growth diameter on the treated media was measured. Each treatment was performed in triplicate. 100% effectiveness was determined by the complete inhibition of fungal growth on the agar surface compared to the negative control.

For nematodal trials, nematodes were collected from both soil and root zones of plants, where nematodes are in direct contact with root tissue, which permitted a close replication of the state in which the agriculturally acceptable formulation of the present disclosure would be applied.

In the laboratory, the extracted nematodes were cleaned to remove organic matter or particles that could interfere with the assay. Each sample was then suspended in an aqueous solution on slides with approximately 30 microliters of water, to which 10 microliters of phenoxyethanol at various concentrations (100% and 90% (with the remainder being water)) was applied. A coverslip was placed over each preparation to facilitate observation using phase-contrast microscopy. During the assay, the nematodes' response to each dose was observed and images were collected.

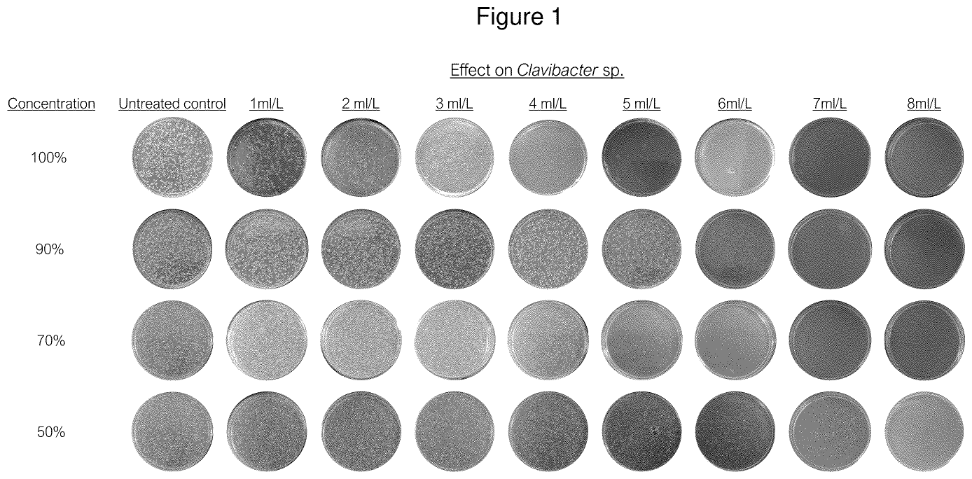

FIG. 1 illustrates the effect of compositions having different concentrations of phenoxyethanol on the growth of Clavibacter sp.

As can be seen in FIG. 1, inhibition of the growth of Clavibacter sp. can be seen, with respect to the 100% concentration composition, at doses as low as 2 ml/L, with complete inhibition being shown beginning at 7 ml/L. For the 90% composition, inhibition may be seen beginning at a dosage of 4 ml/L, with complete inhibition being shown beginning at 7 ml/L. For the 70% composition, inhibition may be seen beginning at a dosage of 4 ml/L, with complete inhibition being shown beginning at 7 ml/L. For the 50% composition, inhibition may be seen beginning at a dosage of 5 ml/L.

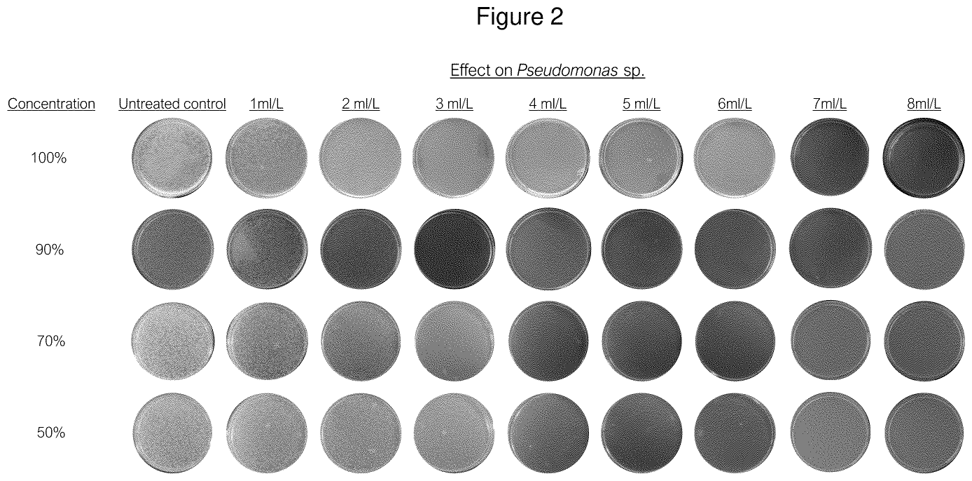

FIG. 2 illustrates the effect of compositions having different concentrations of phenoxyethanol on the growth of Pseudomonas sp.

As can be seen in FIG. 2, inhibition of the growth of Pseudomonas sp. can be seen, with respect to the 100% concentration composition, at doses as low as 1 ml/L, with complete inhibition being shown beginning at 3 ml/L. For the 90% composition, inhibition may be seen beginning at a dosage of 2 ml/L, with complete inhibition being shown beginning at 4 ml/L. For the 70% composition, inhibition may be seen beginning at a dosage of 3 ml/L, with complete inhibition being shown beginning at 4 ml/L. For the 50% composition, inhibition may be seen beginning at a dosage of 4 ml/L, with complete inhibition being shown beginning at 5 ml/L.

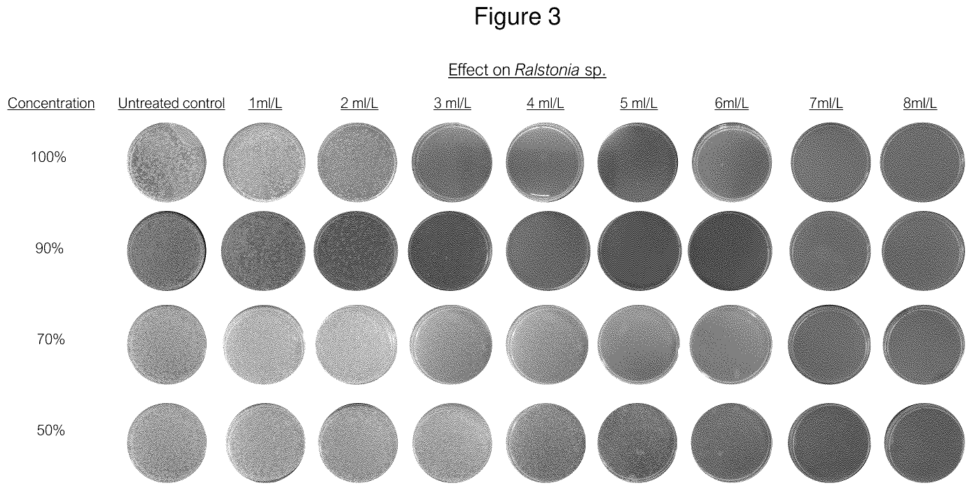

FIG. 3 illustrates the effect of compositions having different concentrations of phenoxyethanol on the growth of Ralstonia sp.

As can be seen in FIG. 3, inhibition of the growth of Ralstonia sp. can be seen, with respect to the 100% concentration composition, at doses as low as 2 ml/L, with complete inhibition being shown beginning at 4 ml/L. For the 90% composition, inhibition may be seen beginning at a dosage of 3 ml/L, with complete inhibition being shown beginning at 6 ml/L. For the 70% composition, inhibition may be seen beginning at a dosage of 5 ml/L, with complete inhibition being shown beginning at 6 ml/L. For the 50% composition, inhibition may be seen beginning at a dosage of 5 ml/L.

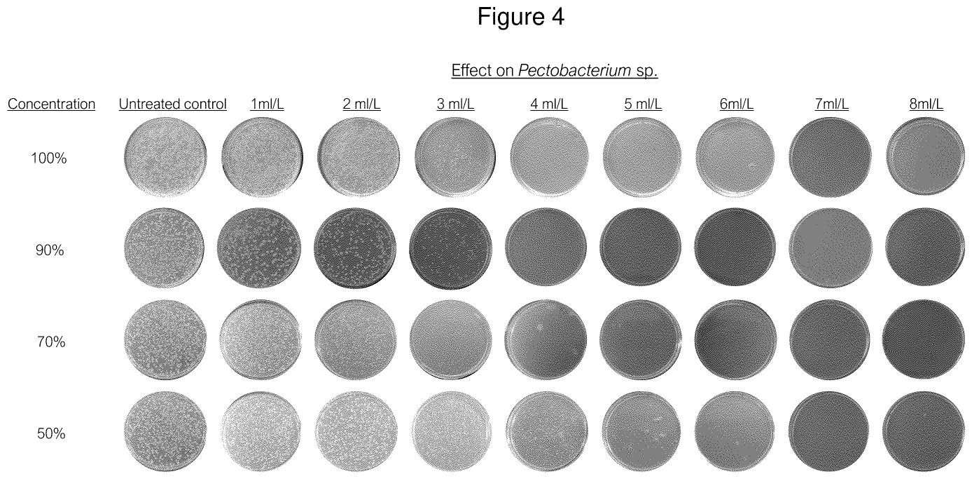

FIG. 4 illustrates the effect of compositions having different concentrations of phenoxyethanol on the growth of Pectobacterium sp.

As can be seen in FIG. 4, inhibition of the growth of Pectobacterium sp. can be seen, with respect to the 100% concentration composition, at doses as low as 2 ml/L, with complete inhibition being shown beginning at 4 ml/L. For the 90% composition, inhibition may be seen beginning at a dosage of 2 ml/L, with complete inhibition being shown beginning at 4 ml/L. For the 70% composition, inhibition may be seen beginning at a dosage of 2 ml/L, with complete inhibition being shown beginning at 5 ml/L. For the 50% composition, inhibition may be seen beginning at a dosage of 3 ml/L.

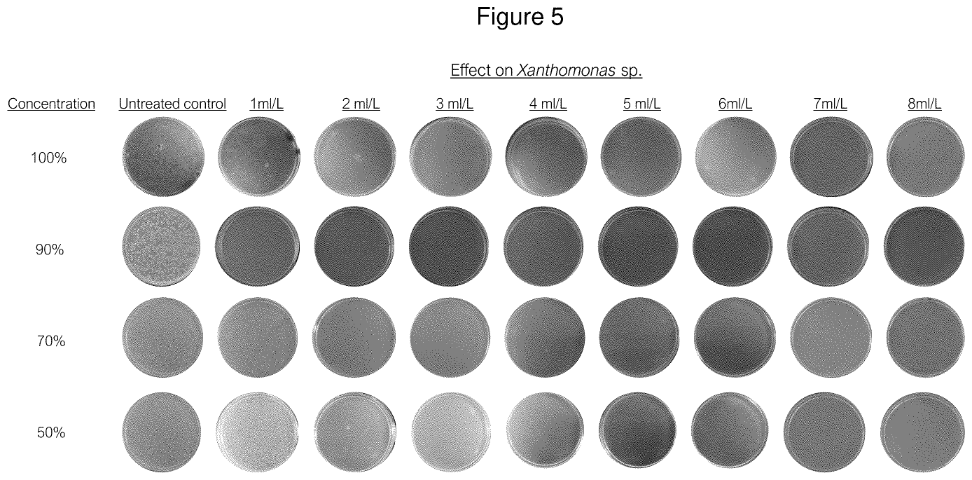

FIG. 5 illustrates the effect of compositions having different concentrations of phenoxyethanol on the growth of Xanthomonas sp.

As can be seen in FIG. 5, inhibition of the growth of Xanthomonas sp. can be seen, with respect to the 100% concentration composition, at doses as low as 1 ml/L, with complete inhibition being shown beginning at 2 ml/L. For the 90% composition, inhibition may be seen beginning at a dosage of 1 ml/L, with complete inhibition being shown beginning at 2 ml/L. For the 70% composition, inhibition may be seen beginning at a dosage of 1 ml/L, with complete inhibition being shown beginning at 2 ml/L. For the 50% composition, inhibition may be seen beginning at a dosage of 2 ml/L, with complete inhibition being shown beginning at 3 ml/L.

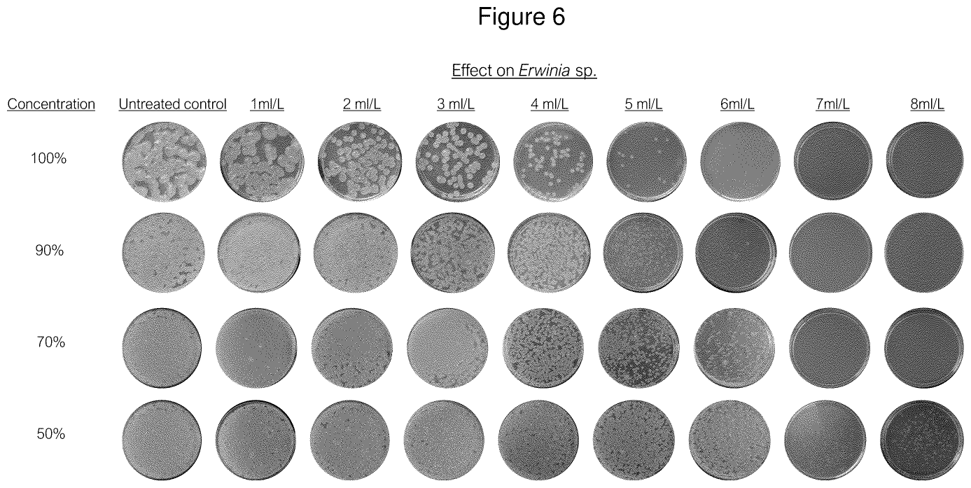

FIG. 6 illustrates the effect of compositions having different concentrations of phenoxyethanol on the growth of Erwinia sp.

As can be seen in FIG. 6, inhibition of the growth of Erwinia sp. can be seen, with respect to the 100% concentration composition, at doses as low as 2 ml/L, with complete inhibition being shown beginning at 7 ml/L. For the 90% composition, inhibition may be seen beginning at a dosage of 3 ml/L, with complete inhibition being shown beginning at 7 ml/L. For the 70% composition, inhibition may be seen beginning at a dosage of 4 ml/L, with complete inhibition being shown beginning at 7 ml/L. For the 50% composition, inhibition may be seen beginning at a dosage of 5 ml/L.

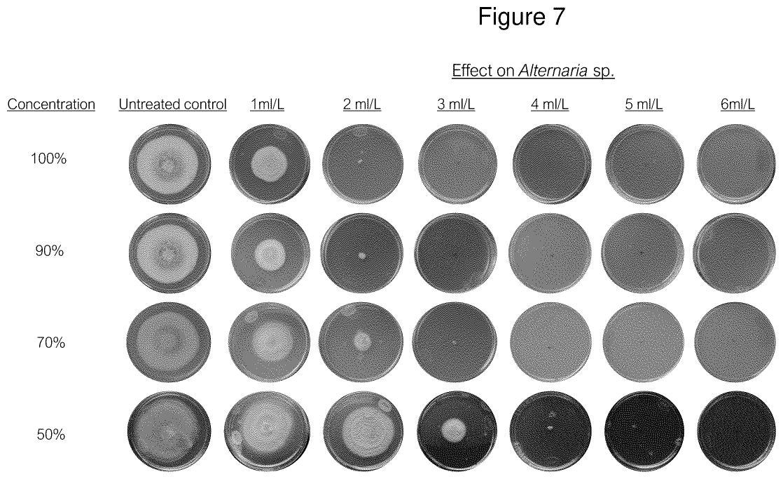

FIG. 7 illustrates the effect of compositions having different concentrations of phenoxyethanol on the growth of Alternaria sp.

As can be seen in FIG. 7, inhibition of the growth of Alternaria sp. can be seen, with respect to the 100% concentration composition, at doses as low as 1 ml/L, with complete inhibition being shown beginning at 3 ml/L. For the 90% composition, inhibition may be seen beginning at a dosage of 1 ml/L, with complete inhibition being shown beginning at 3 ml/L. For the 70% composition, inhibition may be seen beginning at a dosage of 1 ml/L, with complete inhibition being shown beginning at 4 ml/L. For the 50% composition, inhibition may be seen beginning at a dosage of 1 ml/L, with complete inhibition being shown beginning at 5 ml/L.

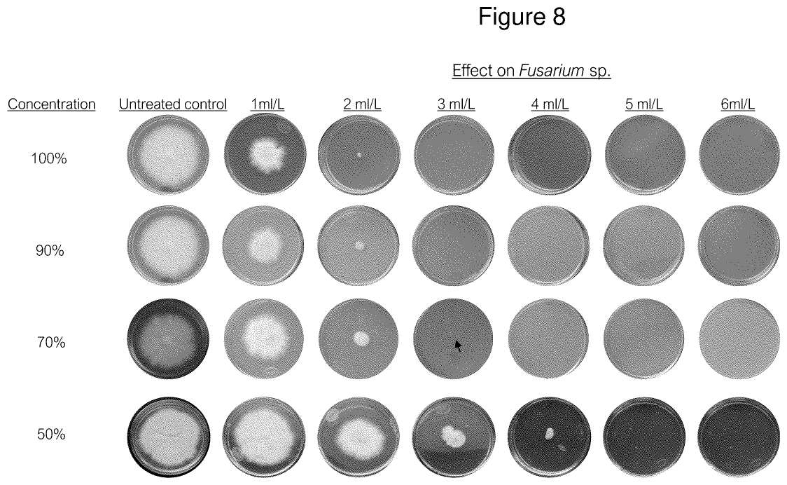

FIG. 8 illustrates the effect of compositions having different concentrations of phenoxyethanol on the growth of Fusarium sp.

As can be seen in FIG. 8, inhibition of the growth of Fusarium sp. can be seen, with respect to the 100% concentration composition, at doses as low as 1 ml/L, with complete inhibition being shown beginning at 3 ml/L. For the 90% composition, inhibition may be seen beginning at a dosage of 1 ml/L, with complete inhibition being shown beginning at 3 ml/L. For the 70% composition, inhibition may be seen beginning at a dosage of 1 ml/L, with complete inhibition being shown beginning at 4 ml/L. For the 50% composition, inhibition may be seen beginning at a dosage of 2 ml/L, with complete inhibition being shown beginning at 5 ml/L.

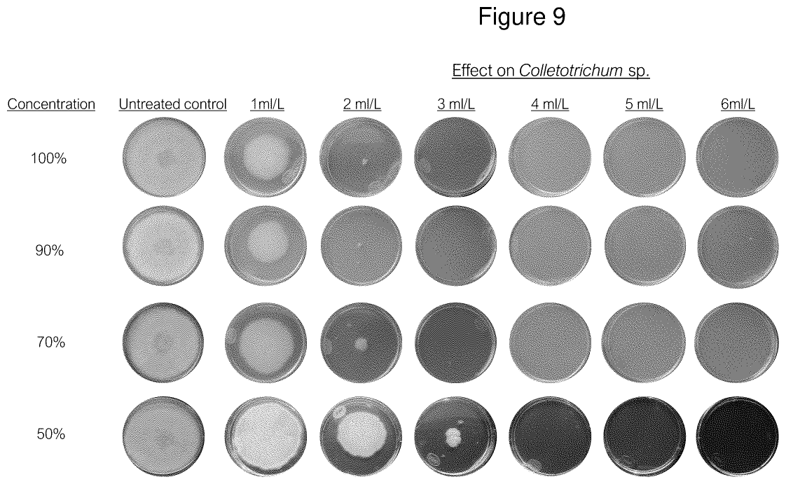

FIG. 9 illustrates the effect of compositions having different concentrations of phenoxyethanol on the growth of Colletotrichum sp.

As can be seen in FIG. 9, inhibition of the growth of Colletotrichum sp. can be seen, with respect to the 100% concentration composition, at doses as low as 1 ml/L, with complete inhibition being shown beginning at 3 ml/L. For the 90% composition, inhibition may be seen beginning at a dosage of 1 ml/L, with complete inhibition being shown beginning at 3 ml/L. For the 70% composition, inhibition may be seen beginning at a dosage of 1 ml/L, with complete inhibition being shown beginning at 3 ml/L. For the 50% composition, inhibition may be seen beginning at a dosage of 2 ml/L, with complete inhibition being shown beginning at 4 ml/L.

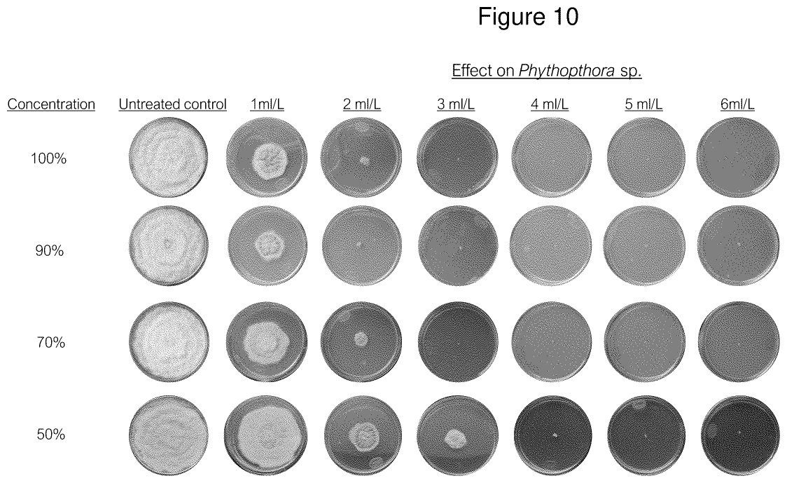

FIG. 10 illustrates the effect of compositions having different concentrations of phenoxyethanol on the growth of Phythopthora sp.

As can be seen in FIG. 10, inhibition of the growth of Phythopthora sp. can be seen, with respect to the 100% concentration composition, at doses as low as 1 ml/L, with complete inhibition being shown beginning at 3 ml/L. For the 90% composition, inhibition may be seen beginning at a dosage of 1 ml/L, with complete inhibition being shown beginning at 3 ml/L. For the 70% composition, inhibition may be seen beginning at a dosage of 1 ml/L, with complete inhibition being shown beginning at 3 ml/L. For the 50% composition, inhibition may be seen beginning at a dosage of 1 ml/L, with complete inhibition being shown beginning at 5 ml/L.

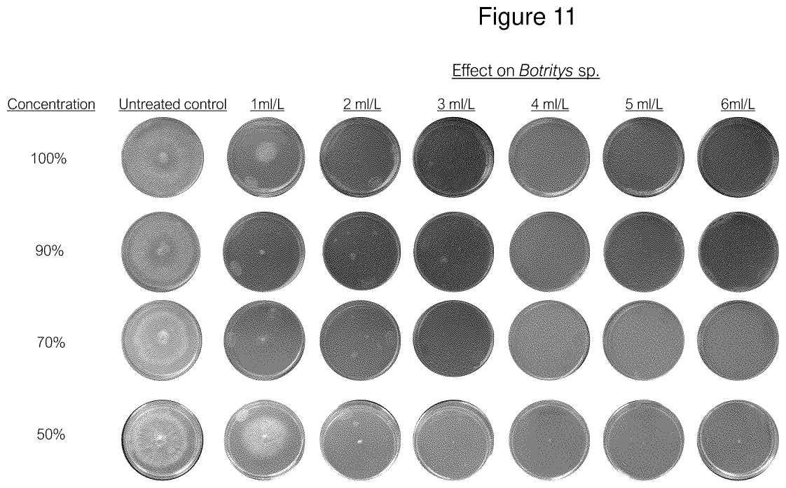

FIG. 11 illustrates the effect of compositions having different concentrations of phenoxyethanol on the growth of Botritys sp.

As can be seen in FIG. 11, inhibition of the growth of Botritys sp. can be seen, with respect to the 100% concentration composition, at doses as low as 1 ml/L, with complete inhibition being shown beginning at 2 ml/L. For the 90% composition, inhibition may be seen beginning at a dosage of 1 ml/L, with complete inhibition being shown beginning at 2 ml/L. For the 70% composition, inhibition may be seen beginning at a dosage of 1 ml/L, with complete inhibition being shown beginning at 2 ml/L. For the 50% composition, inhibition may be seen beginning at a dosage of 1 ml/L, with complete inhibition being shown beginning at 3 ml/L.

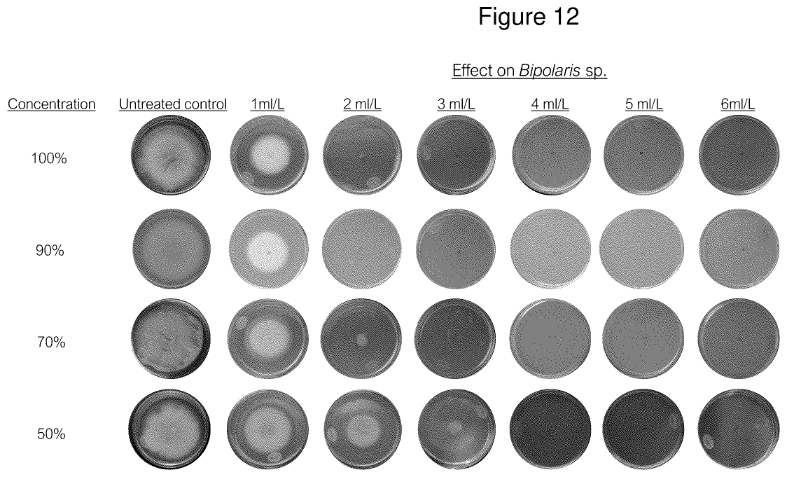

FIG. 12 illustrates the effect of compositions having different concentrations of phenoxyethanol on the growth of Bipolaris sp.

As can be seen in FIG. 12, inhibition of the growth of Bipolaris sp. can be seen, with respect to the 100% concentration composition, at doses as low as 1 ml/L, with complete inhibition being shown beginning at 3 ml/L. For the 90% composition, inhibition may be seen beginning at a dosage of 1 ml/L, with complete inhibition being shown beginning at 3 ml/L. For the 70% composition, inhibition may be seen beginning at a dosage of 1 ml/L, with complete inhibition being shown beginning at 3 ml/L. For the 50% composition, inhibition may be seen beginning at a dosage of 1 ml/L, with complete inhibition being shown beginning at 4 ml/L.

Thus, these experiments show that the presently disclosed agriculturally acceptable composition containing phenoxyethanol prevents bacterial and fungal growth.

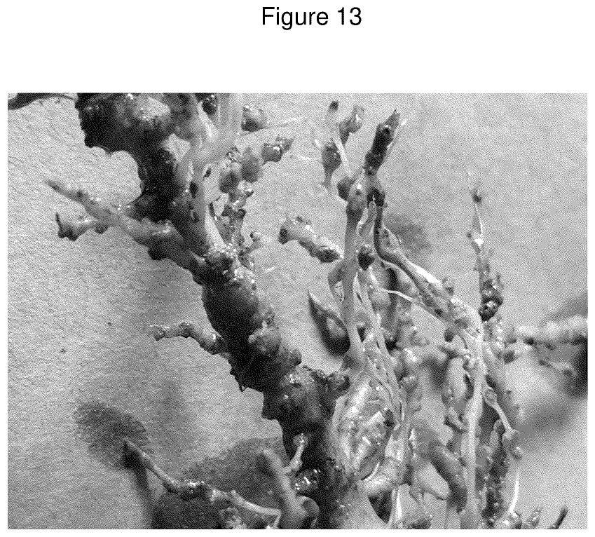

FIG. 13 shows a root used to extract nematodes. As illustrated in FIG. 13, a significant amount of root damage is evident, with some roots appearing thickened and deformed, and the root displayed numerous nodules caused by nematode damage. This compromised root system had a reduced absorption capacity and was highly susceptible to bacterial and fungal rot as a result of the nematode infestation. In turn, these effects would have minimized crop yield and diminished the genetic potential of the plant.

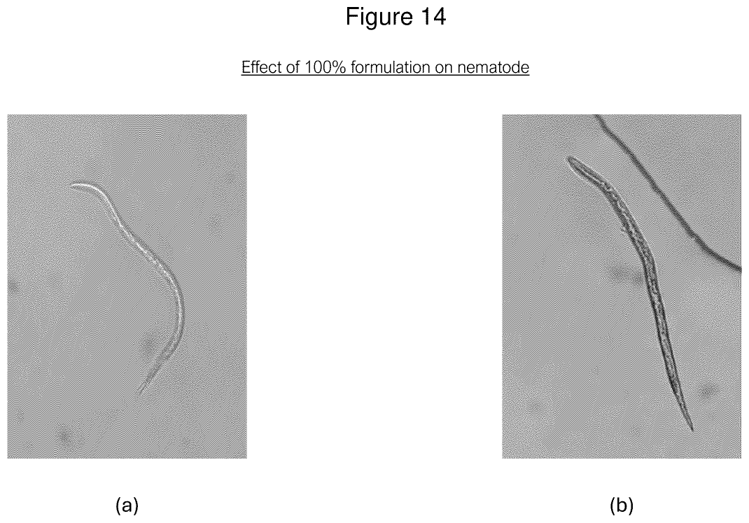

FIG. 14(a) shows a nematode extracted from the root in FIG. 13 prior to the administration of a 100% phenoxyethanol formulation. FIG. 14(b) shows the nematode about 15 minutes after administration. Prior to administration (FIG. 14(a)), the nematode showed a flexed posture, and formed curves along its body. In contrast, after the formulation was applied (FIG. 14(b)), the nematode appeared straight, without curves, revealing denaturation in its cuticle, and was motionless. This indicates that the nematode is dead in FIG. 14(b). FIGS. 14(a) and (b) were taken at 10× magnification.

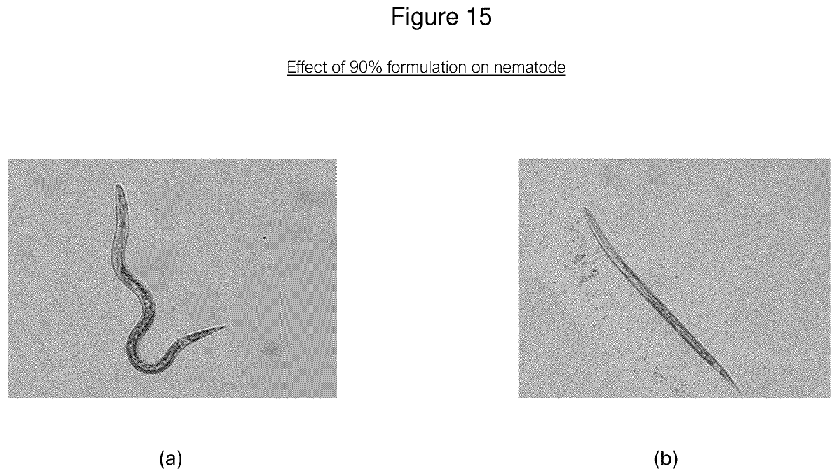

FIG. 15(a) shows a nematode extracted from the root in FIG. 13 prior to the administration of a 90% phenoxyethanol formulation. FIG. 15(b) shows the nematode about 15 minutes after administration. Prior to administration (FIG. 15(a)), the nematode showed a flexed posture, and formed curves along its body. In contrast, after the formulation was applied (FIG. 15(b)), the nematode appeared straight, without curves, revealing denaturation in its cuticle, and was motionless. This indicates that the nematode is dead in FIG. 15(b). FIGS. 15(a) and (b) were taken at 10× magnification.

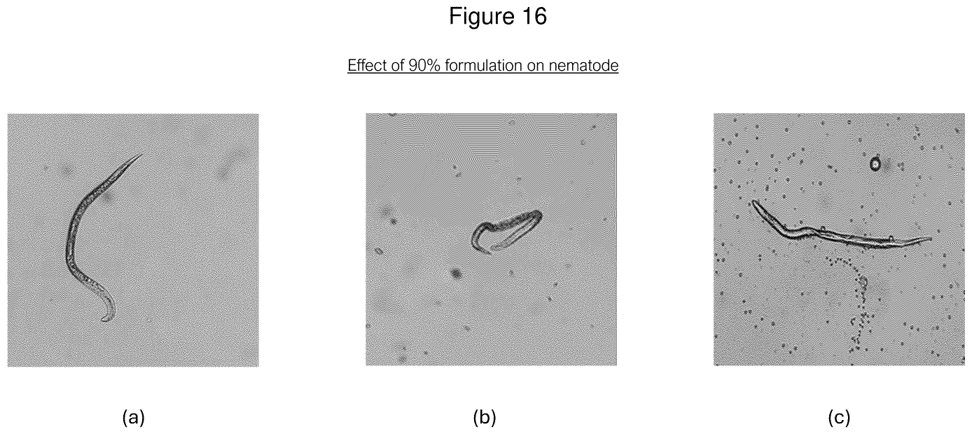

FIGS. 16(a)-(c) show three stages of nematode life and death following administration of a 90% phenoxyethanol formulation. FIG. 16(a) shows a nematode prior to administration of the phenoxyethanol formulation. In FIG. 16(a), the nematode was alive, with its body forming natural curves, and was observed in full motion. FIG. 16(b) shows the nematode immediately after contact with the phenoxyethanol formulation. FIG. 16(b) shows that immediately upon contact, the nematode curled and bent its ends inward, forming a semicircle. FIG. 16(c) shows the nematode about 15 minutes after administration of the phenoxyethanol formulation. In FIG. 16(c), the nematode was dead—it was rigid, in almost fully extended position, and displayed no movement. FIGS. 16(a)-(c) were taken at 10× magnification.

The nematode test results showed that upon initial contact with the tested formulations, all of the observed nematodes exhibited an immediate and observable behavioral reaction, characterized by increased and erratic movements, suggesting a rapid onset of the presently disclosed formulation's effects. This was followed by a gradual descent to the bottom of the solution and a loss of their characteristic undulating shape. The time range for complete immobility averaged approximately 15 minutes, marking the endpoint of neuromuscular and cuticular effects. This final immobilization, accompanied by a rigid, straight posture, confirmed that the applied formulation generated a potent nematicidal effect, visibly degrading the cuticle and causing external abrasion.

This progressive effect—from excitation to immobility—indicates that phenoxyethanol does not act instantaneously as a shock toxicant, but as an agent that gradually interferes with the nematode's vital processes, affecting its ability to locomotion, feed and survive. In the agricultural context, this indicates that the present composition would be expected to have similar nematicidal against other nematodes.

As seen in the Examples above, a clear dose-response relationship was observed, meaning that the higher the dose and concentration of phenoxyethanol, the greater the level of control over the pathogens. These tests demonstrated the use of phenoxyethanol as an effective tool for managing these pathogens. For example, with respect to the tested bacteria, colony growth decreased in size, thickness, and aggressiveness as the applied dose increased. The action of phenoxyethanol on the tested fungi was evidenced by the reduction of sporulation, mycelial growth, and the formation of fruiting bodies, which inhibits the spread of these pathogens under high humidity conditions, which is a key factor in their propagation.

These results are unexpected and extremely promising, as phenoxyethanol has not previously been used in agriculture for the control of these organisms. Its potential as a tool within integrated disease management, allowing rotation with other active ingredients, positions it as an innovative and sustainable solution to address current phytopathological challenges in agriculture.

The present formulations can be safely used in the field. The following table shows projected water volume per hectare used in crops such as vegetables and fruit trees. The first column indicates the water volume per hectare, while the second details the number of liters per hectare of pure active ingredient. The third column reflects the milliliters per liter of the product, which in this exemplified embodiment is 7 ml. Subsequently, the final percentage concentration of the water mixture is presented, and finally, the concentration in parts per million (ppm). This illustrates that even at a dose of 7 ml/L, less than 1% of the active ingredient may be present in the composition, which is safe for those applying the composition.

TABLE 1

| | Product | mL/L | Concen- | Concen- |
|---|---|---|---|---|
| Water Volume | Used | of | tration | tration |
| (L/ha) | (L/ha) | Product | (%) | (ppm) |
| 400 | 2.8 | 7 | 0.695 | 6950 |
| 600 | 4.2 | 7 | 0.695 | 6950 |
| 800 | 5.6 | 7 | 0.695 | 6950 |
| 1000 | 7 | 7 | 0.695 | 6950 |

The effectiveness of the composition was tested against nematodes in a greenhouse setting. In a greenhouse with a history of infestation by Meloidogyne incognita, which is a root-knot nematode that causes serious losses in vegetables of agricultural importance such as tomatoes, compositions of the present composition were tested.

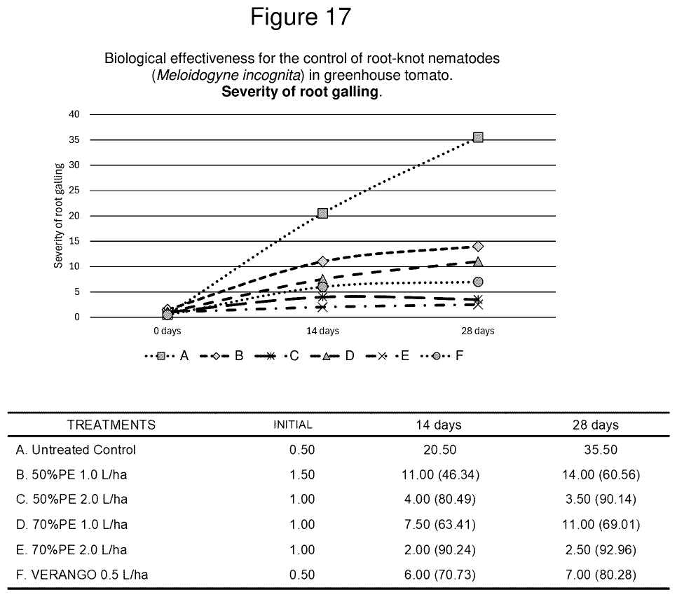

FIG. 17 illustrates the effectiveness of compositions of 50% phenoxyethanol (PE) and 50% surfactant by volume and compositions of 70% phenoxyethanol and 30% surfactant by volume. The surfactants used were TOXIMUL 3473F (a blend of calcium sulfonate and a nonionic surfactant) and the nonionic surfactants TOXIMUL 8240 (castor oil ethoxylate, POE-36) and STEP-FLOW 26F (polyalkylene oxide block copolymer), each sold by Stephan Company. The 70% phenoxyethanol composition contained 70% by volume phenoxyethanol, 21% by volume TOXIMUL 3473F, 6% by volume TOXIMUL8240, and 3% by volume STEP-FLOW 26F. The 50% phenoxyethanol composition contained 50% by volume phenoxyethanol, 35% by volume TOXIMUL 3473F, 10% by volume TOXIMUL8240, and 5% by volume STEP-FLOW 26F. These compositions were mixed with 500 L of water per hectare for application. In the 1 L/ha applications, 1 L of the composition was mixed with 500 L of water. In the 2 L/ha applications, 2 L of the composition was mixed with 500 L of water. These compositions were tested against an untreated control and the known nematicide VERANGO, which contains fluoropyram in an amount of 41.66% by volume. The compositions were administered in the amounts shown in the figure.

In the Example shown in FIG. 17, a greenhouse with tomato plants approximately 50 days after transplanting, in the fourth flowering stage, was used. An initial evaluation of the severity of galling in roots was carried out, finding values between 0.5 and 1.5%, with no statistical differences between them. Soil samples (100 cm³) were taken to confirm the presence of infective juvenile larvae (J2) of M. incognita and other phytoparasitic nematodes. After the initial evaluation, the first application of treatments in the form of drench to the base of the plants was carried out.

14 days after the first application, the root galling index was evaluated. As seen in FIG. 17, the untreated control reached 20.50% severity, which was significantly higher than all of the samples that had nematicide treatments. Different levels of efficacy were detected between doses and formulations, as shown in the figure. FIG. 17 shows the severity of root galling and, in parentheses in the Table therein, shows the efficacy (% efficacy of Abbott treatments) as compared to the untreated control. The 50% phenoxyethanol solutions showed efficacies of 46.34% and 80.49%, respectively, and the 70% phenoxyethanol solutions showed efficacies of 63.41% and 90.24%, respectively. The fluopyram composition exhibited 70.73% efficacy. As seen in FIG. 17, after 14 days, the doses of 2.0 L/ha of phenoxyethanol (both 50% and 70%) were the most outstanding, exceeding 80% efficacy and showing better performance than the commercial standard fluoropyram, which was administered in the amount recommended by the manufacturer. Following evaluation, a second application of treatments was administered.

28 days after the first application, the root galling index was again evaluated. As seen in FIG. 17, the untreated control registered the highest severity with 35.50%, which was statistically different from the other groups. FIG. 17 shows that the 50% phenoxyethanol solutions exhibited efficacies of 60.56% and 90.14%. The 70% phenoxyethanol solutions exhibited efficacies of 69.01% and 92.95%. The fluopyram solution exhibited an efficacy of 80.28%.

The compositions shown in FIG. 17 were evaluated for statistical deviations for each other, and the results are shown in the Table below:

| TREATMENTS | Initial | 14 Days | | 28 Days | |
|---|---|---|---|---|---|
| A. Untreated | 0.50 A | 20.50 A | | 35.50 A | |
| Control | | | | | |
| B. 50% PE | 1.50 A | 11.00 | (46.34) B | 14.00 | (60.56) B |
| 1.0 L/ha | | | | | |
| C. 50% PE | 1.00 A | 4.00 | (80.49) BC | 3.50 | (90.14) C |
| 2.0 L/ha | | | | | |
| D. 70% PE | 1.00 A | 7.50 | (63.41) BCD | 11.00 | (69.01) BC |
| 1.0 L/ha | | | | | |
| E. 70% PE | 1.00 A | 2.00 | (90.24) C | 2.50 | (92.96) C |
| 2.0 L/ha | | | | | |
| F. VERANGO | 0.50 A | 6.00 | (70.73) BCD | 7.00 | (80.28) BC |
| 0.5 L/ha | | | | | |

Within each column, values having the same letter were not deemed to be statistically different from each other (Duncan=0.05). For example, all initial values were graded “A” and thus were not different from each other; similarly, “B” values were more effective than “A” values, and so forth. Higher letters represented higher efficacy. Values labeled, for example, BCD, overlap statistically with values from B, C, and D, whereas values labeled, for example, C, overlap only with values labeled with a C.

FIG. 17 thus shows that the compositions containing phenoxyethanol successfully treat or prevent nematodal infections, inhibiting the severity of root galling over the untreated control.

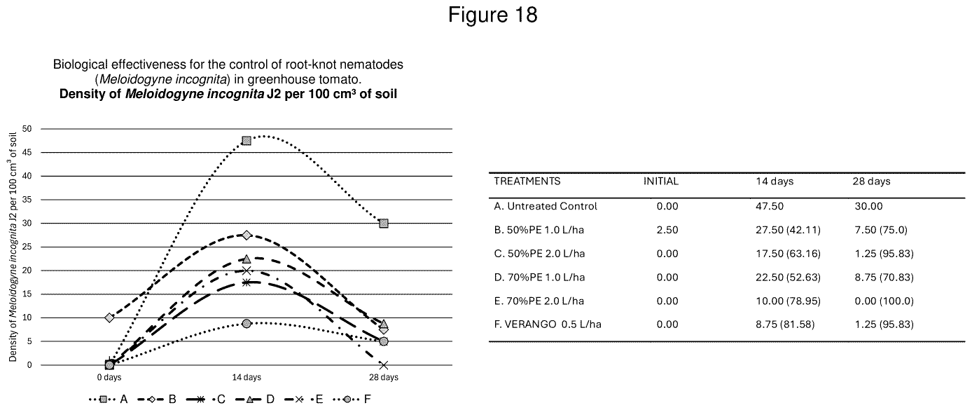

During the greenhouse test illustrated in FIG. 17, composite soil samples (4 samples per treatment) were collected to quantify the population of J2 larvae. FIG. 18 shows the results of these tests. FIG. 18 shows that all of the phenoxyethanol-containing compositions showed acceptable control of the J2 larvae of Meloidogyne spp. and other phytoparasitic nematodes. For example, the 70% phenoxyethanol composition applied at 2.0 L/ha showed complete control of the nematodes.

The compositions shown in FIG. 18 were evaluated for statistical deviations for each other, and the results are shown in the Table below:

| TREATMENTS | Initial | 14 Days | | 28 Days | |
|---|---|---|---|---|---|
| A. Untreated | 0.00 A | 47.50 A | | 30.00 A | |
| Control | | | | | |
| B. 50% PE | 2.50 A | 27.50 | (42.11) AB | 7.50 | (75.0) BC |
| 1.0 L/ha | | | | | |
| C. 50% PE | 0.00 A | 17.50 | (63.16) B | 1.25 | (95.83) CD |
| 2.0 L/ha | | | | | |
| D. 70% PE | 0.00 A | 22.50 | (52.63) B | 8.75 | (70.83) B |
| 1.0 L/ha | | | | | |
| E. 70% PE | 0.00 A | 10.00 | (78.95) B | 0.00 | (100.0) D |
| 2.0 L/ha | | | | | |
| F. VERANGO | 0.00 A | 8.75 | (81.58) B | 1.25 | (95.83) CD |
| 0.5 L/ha | | | | | |

FIG. 18 thus also shows that populations of nematodes may be prevented or reduced, or may be treated, using the composition.

Through the greenhouse trials, the crops exhibited no phytotoxic effects.

With respect to nematodes, Meloidogyne is highly representative as the main organism in field experiments, since it is considered a reference model in agricultural nematology. Its recurrent presence in producing areas, combined with its high capacity for multiplication and dispersion, make it an excellent indicator of the efficacy potential of an active ingredient for other nematodes. In fact, the interaction of Meloidogyne with other soil pathogens, such as Fusarium and Ralstonia, enhances the development of disease complexes that aggravate yield losses, reinforcing its value as a key organism for validating new control molecules. Results obtained in the field against Meloidogyne not only validate the initial efficacy of this novel composition, but also are representative of the ability of the composition to treat and prevent other nematodes with similar characteristics.

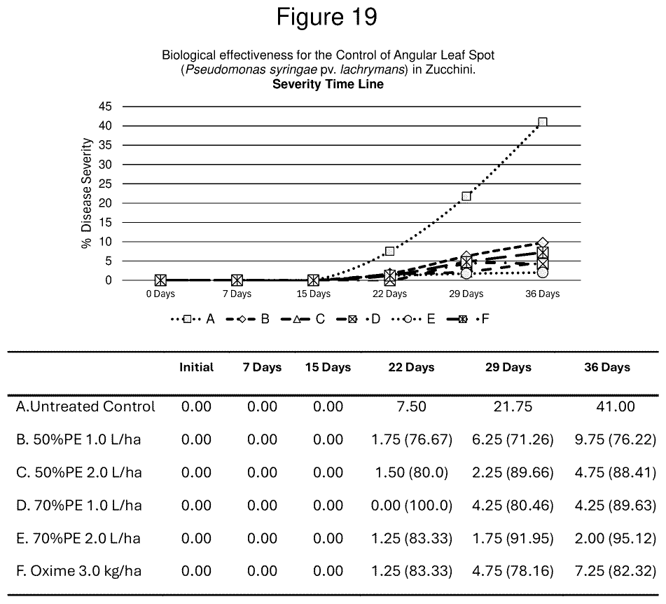

The biological effectiveness of the present compositions were tested for the control of the bacterial angular spot Pseudomonas syringae pv. Lachrymans on zucchini plants, and the results are shown in FIG. 19. In this Example, the severity of the angular spot was measured as per Townsend and Heuberger.

In total, five applications were made with 7 days between each of them. An evaluation was carried out prior to the first application prior to each of the subsequent applications, in addition to a final evaluation. This application proved effective to contain the disease under high pressure, and the results show that the present composition may be applied on an early preventive or curative schedule, which allows for flexibility in integration with other management practices.

The 70% phenoxyethanol composition shown in FIG. 19 contained 70% by volume phenoxyethanol, 21% by volume TOXIMUL 3473F, 6% by volume TOXIMUL8240, and 3% by volume STEP-FLOW 26F. The 50% phenoxyethanol composition contained 50% by volume phenoxyethanol, 35% by volume TOXIMUL 3473F, 10% by volume TOXIMUL8240, and 5% by volume STEP-FLOW 26F. These compositions were mixed with 400 L of water per hectare for application. In the 1 L/ha applications, 1 L of the composition was mixed with 400 L of water. In the 2 L/ha applications, 2 L of the composition was mixed with 400 L of water. These compositions were tested against an untreated control and the commercial standard OXIME, which contains copper oxychloride in an amount of 50% by volume. The compositions were administered in the amounts shown in the figure via spraying with a sprinkler and a three-nozzle cone boom.

As can be seen in FIG. 19, the disease did not appear in any of the samples until the day 22 measurement, and for the 70% phenoxyethanol composition applied at 1 L/ha, the disease did not appear until the 29 day measurement. At the 22-day measurement, the untreated control had the highest severity, measuring 7.5%. The 1 L/ha application of the 50% phenoxyethanol composition provided for a biological effectiveness of 76.67%, while the other compositions where the disease appeared showed effectivenesses as shown in the figure.

By the final evaluation, the untreated control had a severity of 43%, whereas the compositions of the present disclosure showed prevention, with efficacies of 76.22%, 88.41%, 89.63%, and 95.12%, respectively. Some of these were better than the industry-standard OXIME, which had an effectiveness of 82.32%. Thus, the tested compositions shown in FIG. 19 consistently maintained lower severity values compared to the untreated control which were, in some cases, comparable to or higher than the commercial standard.

In the untreated control in the Example of FIG. 19, progressive symptoms of angular spots on the foliage were observed, characterized by necrotic lesions delimited by veins, bacterial exudates and generalized chlorosis in advanced stages. In contrast, the compositions of the present disclosure showed a visible reduction in the extent and severity of these lesions. The treated plants retained greater functional leaf area and less defoliation, which resulted in a better overall physiological state at the end of the trial.

The compositions shown in FIG. 19 were evaluated for statistical deviations (Tukey=0.05) for each other, and the results are shown in the Table below:

| | Initial | 7 Days | 15 Days | 22 Days | 29 Days | 36 Days |
|---|---|---|---|---|---|---|
| A. Untreated Control | 0.00 | 0.00 | 0.00 | 7.50 A | 21.75 A | 41.00 A |
| B. 50% PE 1.0 L/ha | 0.00 | 0.00 | 0.00 | 1.75 (76.67) B | 6.25 (71.26) B | 9.75 (76.22) B |
| C. 50% PE 2.0 L/ha | 0.00 | 0.00 | 0.00 | 1.50 (80.0) B | 2.25 (89.66) B | 4.75 (88.41) CD |
| D. 70% PE 1.0 L/ha | 0.00 | 0.00 | 0.00 | 0.00 (100.0) B | 4.25 (80.46) B | 4.25 (89.63) CD |
| E. 70% PE 2.0 L/ha | 0.00 | 0.00 | 0.00 | 1.25 (83.33) B | 1.75 (91.95) B | 2.00 (95.12) D |
| F. OXIME 3.0 kg/ha | 0.00 | 0.00 | 0.00 | 1.25 (83.33) B | 4.75 (78.16) B | 7.25 (82.32) BC |

This Example thus shows the preventative and curative impact of the present composition, even under high disease pressure.

During the trial, no visible symptoms of phytotoxicity were observed in the plants treated with the present composition, even at the highest doses evaluated. The foliage maintained a uniform green color, with no necrosis or deformations, indicating that the active ingredient is safe for cultivation under the tested application conditions.

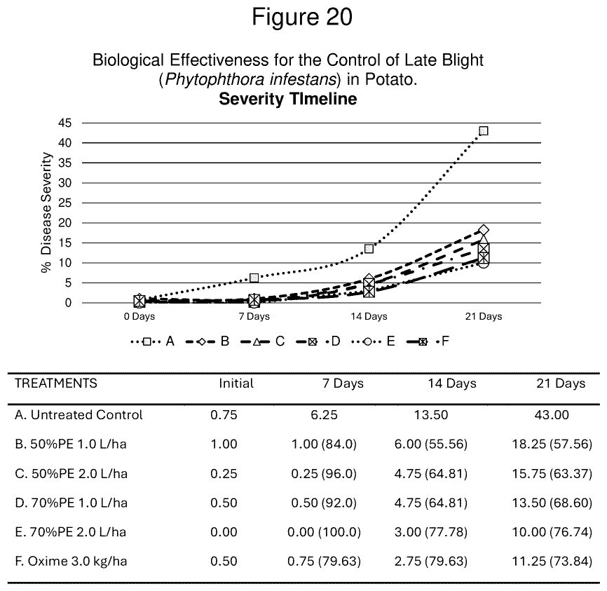

FIG. 20 illustrates the effectiveness of the present compositions against the potato fungus Phytophthora infestans. The compositions were tested against an untreated control and the commercial standard OXIME, which contains 50% by volume copper oxychloride.

The 70% phenoxyethanol composition shown in FIG. 20 contained 70% by volume phenoxyethanol, 21% by volume TOXIMUL 3473F, 6% by volume TOXIMUL8240, and 3% by volume STEP-FLOW 26F. The 50% phenoxyethanol composition contained 50% by volume phenoxyethanol, 35% by volume TOXIMUL 3473F, 10% by volume TOXIMUL8240, and 5% by volume STEP-FLOW 26F. These compositions were mixed with 400 L of water per hectare for application. In the 1 L/ha applications, 1 L of the composition was mixed with 400 L of water. In the 2 L/ha applications, 2 L of the composition was mixed with 400 L of water. These compositions were tested against an untreated control and the commercial standard OXIME, which contains copper oxychloride in an amount of 50% by volume. The compositions were administered in the amounts shown in the figure via spraying with a backpack sprayer and a three-nozzle cone boom.

As seen in FIG. 20, three applications were carried out with 7 days between them. An evaluation was carried out prior to the first application and prior to each subsequent application. A fourth application was not performed due to the level of severity present in some units, especially the untreated control. In this Example, the severity of the angular spot was measured as per Townsend and Heuberger.

In the initial evaluation, initial symptoms of the disease were found, although the severity did not exceed 1% on average, and thus this was a condition that was considered ideal for the establishment of this Example.

In the first evaluation, the severity of the disease increased exponentially in the untreated control, reaching a value of 6.25 which was statistically different from the treated areas, which had no statistical differences between them, with disease severities between 0 and 1.0%, and effectivenesses between 84.0 and 100%.

In the second evaluation, the severity increased again, particularly in the untreated control with a value reaching 13.50, which was statistically different from the treated areas, which were again each located at the same statistical level as each other. Considering their biological effectiveness, the treatments were considered effective as follows: the 50% phenoxyethanol solution administered at 1.0 L/ha provided for a severity value of 6.0% and an effectiveness of 55.56%; the 50% phenoxyethanol solution administered at 2.0 L/ha and the 70% phenoxyethanol solution administered at 1.0 L/ha provided for a severity value of 4.75% (64.81% effectiveness); the 70% phenoxyethanol solution administered at 2.0 L/ha provided for a severity value of 3.0% (77.78% effectiveness); and finally the commercial control (OXIMET 3.0 kg/ha Copper Oxychloride 50%) with a severity value of 2.75% (79.63% effectiveness).

In the third evaluation, the severity of the disease increased again, especially in the untreated control, which reached a value of 43.0% and was statistically different from the treated areas, which provided for 3 statistically distinct effectivenesses. The first group included the 50% phenoxyethanol solution administered at 1.0 L/ha, which provided for a severity of 18.25% and a biological effectiveness of 57.56%. The second statistical level included the 50% phenoxyethanol solution administered at 2.0 L/ha, which provided for a severity of 15.75% (63.37% effectiveness). The third statistical level included the commercial control treatment (OXIMET 3.0 kg/ha), which provided for a severity of 11.25% (73.84% effectiveness), and the 70% phenoxyethanol solution administered at 2.0 L/ha, which provided for a severity of 10.0% (76.74% effectiveness).

The compositions shown in FIG. 20 were evaluated for statistical deviations (Tukey=0.05) for each other, and the results are shown in the Table below:

| TREATMENTS | Initial | 7 Days | 14 Days | 21 Days |
|---|---|---|---|---|
| A. Untreated | 0.75 A | 6.25 A | 13.50 A | 43.00 A |
| Control | | | | |
| B. 50% PE | 1.00 A | 1.00 | 6.00 | 18.25 |
| 1.0 L/ha | | (84.0) B | (55.56) B | (57.56) B |
| C. 50% PE | 0.25 A | 0.25 | 4.75 | 15.75 |
| 2.0 L/ha | | (96.0) B | (64.81) B | (63.37) BC |
| D. 70% PE | 0.50 A | 0.50 | 4.75 | 13.50 |
| 1.0 L/ha | | (92.0) B | (64.81) B | (68.60) BCD |
| E. 70% PE | 0.00 A | 0.00 | 3.00 | 10.00 |
| 2.0 L/ha | | (100.0) B | (77.78) B | (76.74) D |
| F. OXIME | 0.50 A | 0.75 | 2.75 | 11.25 |
| 3.0 kg/ha | | (79.63) B | (79.63) B | (73.84) CD |

None of the treatments showed symptoms of phytotoxicity in the crop after three foliar applications with a periodicity of 7 days between each.

The results shown in FIG. 20 show that the present compositions, in the 70% formulation at a dose of 2.0 L/ha showed the greatest effectiveness in the field, reaching 76.74% control of potato late blight, under conditions of high inoculum pressure and a highly favorable environment for the development of the disease. The results with the 50% formulation are also surprisingly good results because of how aggressive Phytophthora infestans is.

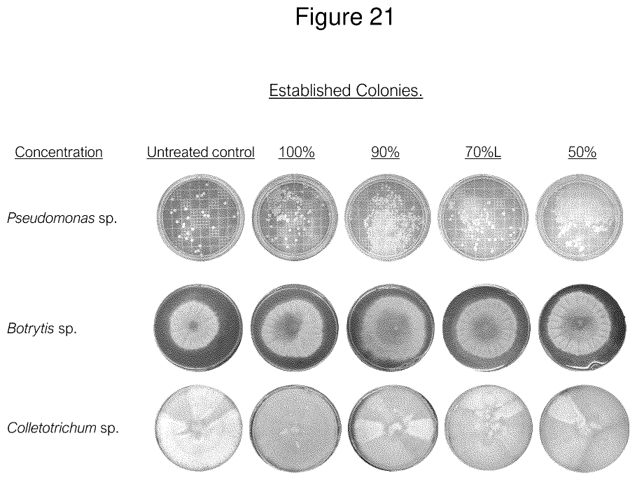

To determine whether the inventive compositions could permeate through the biofilm that forms in established bacterial and fungal colonies, laboratory tests were conducted. FIG. 21 shows the results from the tests. In these tests, petri dishes including a culture medium grew untreated colonies of bacteria and then inventive compositions were applied to the established colonies.

To perform these tests for pseudomonas sp., nutrient agar plates were prepared and inoculated with a Pseudomonas bacterial suspension adjusted to 0.5 on the McFarland scale and subsequently diluted to a ratio of 1:10,000. From the first dilution, 1 μL was taken and added to 999 μL of sterile water, achieving a population of ≤100 CFU per plate, corresponding to a final concentration of between 1×10⁶ and 9×10⁶ CFU/mL. The plates were then incubated for 4 hours at 28° C. prior to application of the inventive compositions.

Sprinklers were prepared with 60 mL of sterile water, one for each tested phenoxyethanol formulation (100%, 90%, 70% and 50%), applied at a dose of 8 mL/L. The solutions were kept under constant magnetic agitation to ensure homogeneity. The sprays were carried out inside a biosafety cabin, applying two passes per plate to completely cover the surface of the medium. The plates were then incubated for 42 hours at 28° C. before evaluation.

To perform the tests for Botrytis sp. and Colletotrichum sp., potato dextrose agar (PDA) plates were prepared. For Botrytis sp., ⅛ of an active mycelium disc was placed. For Colletotrichum sp., 10 μL of a 1:10,000 dilute fungal suspension was inoculated. The plates were incubated for 24 hours at 28° C. to allow for the initial establishment of the pathogen. Sprinklers were prepared with 60 mL of sterile water, one for each phenoxyethanol formulation (100%, 90%, 70% and 50%), applied at a dose of 8 mL/L. All solutions were kept under constant agitation on magnetic plate to ensure homogeneity.

After the initial incubation period, the plates were sprayed twice per surface inside a biosafety cabinet, and then incubated for an additional period until a total of 42 hours elapsed.

In the above procedures, the pathogens were successfully established during their initial growth phase in the nutrient-rich environment. The conditions present inside the petri dishes—particularly temperature, humidity, and the presence of wastewater from the sprayed product—favored an optimal environment for colony dispersal and more vigorous growth.

Unlike the previous test (poisoned media/amended media), in this case the culture medium was not impregnated or mixed with the active ingredient (phenoxyethanol). This factor allows us to infer that the product exerts its effect mainly during the initial stages of microbial development. When phenoxyethanol is integrated into the culture medium, bacteria and fungi face it from the beginning of their metabolism, at which time the compound manages to inhibit cell growth and multiplication.

FIG. 21 illustrates that the inventive compositions did not appear to infiltrate the biofilms present in established colonies of the noted bacteria or fungi, since the colonies did not diminish in size. Any growth observed was attributed to the additional water added during the spraying process.

The results in FIG. 21 show that the present invention exhibits excellent prevention and treatment of bacteria and fungus as shown in the laboratory tests and field trials reported herein, but they may not be able to infiltrate the biofilms in established colonies. Thus, the present inventive compositions effectively treat infestations by limiting germination and the initial establishment of pathogens, but may exhibit decreased efficiency when faced with consolidated colonies with fully developed metabolism in laboratory conditions. The present inventive compositions provide a hostile environment for pathogens at the beginning of their life cycle, preventing the development of new colonies and reducing the probability of secondary cycles of disease.

The present inventors have therefore shown that phenoxyethanol significantly controls and prevents phytopathogenic fungi, bacteria, and nematodes that affect crops such as vegetables, cereals, fruit trees, and other agriculturally important plants. It should be understood that the present disclosure is not limited to the embodiments exemplified herein.

1. A method of treating and/or preventing a disease in plants, comprising a step of administering a composition comprising phenoxyethanol to a plant.

2. A method of treating and/or preventing a nematodal infestation in plants, comprising a step of administering a composition comprising phenoxyethanol to a plant.

3. The method according to claim 1, comprising administering the composition to at least one of the plant's foliage, stem, canopy, trunk, roots, shoots, twigs, or flowers.

4. The method according to claim 1, comprising administering the composition to at least one of the plant's seeds or rhizomes.

5. The method according to claim 1, wherein the composition is administered to the plant at least twice at an interval of from 1-21 days.

6. The method according to claim 1, wherein the composition is administered during the plant's seedling stage, transplant stage, vegetative stage, pre-bloom stage, full-bloom stage, post-bloom stage, fruit set stage, or dormancy.

7. The method according to claim 1, wherein the plant is a vegetable plant, a cereal plant, a fruit plant, a nut plant, or sugar cane.

8. The method according to claim 1, wherein the plant is a fruit tree.

9. The method according to claim 1, wherein the disease is caused by a bacteria or fungi.

10. The method according to claim 1, wherein the disease is caused by Clavibacter sp., Pseudomonas sp., Ralstonia sp., Pectobacterium sp., Xanthomonas sp., Erwinia sp., Alternaria sp., Fusarium sp., Colletotrichum sp., Phythopthora sp., Botritys sp., or Bipolaris sp.

11-12. (canceled)

13. A composition comprising phenoxyethanol configured to be applied to plants and which is used to treat and/or prevent a disease in plants or a nematodal infestation in plants.

14. The composition according to claim 13, wherein the phenoxyethanol is present in the composition in an amount of from 0.01 ml/L to 100 ml/L of the composition.

15-17. (canceled)

18. The composition according to claim 14, wherein the phenoxyethanol is present in the composition in an amount of from 3 ml/L to 9 ml/L of the composition.

19. The composition according to claim 13, wherein the phenoxyethanol is present in the composition in an amount sufficient to treat and/or prevent bacteria and/or fungal diseases, or an amount sufficient to kill nematodes or prevent nematodal infestations.

20. The method according to claim 2, comprising administering the composition to at least one of the plant's foliage, stem, canopy, trunk, roots, shoots, twigs, or flowers.

21. The method according to claim 2, comprising administering the composition to at least one of the plant's seeds or rhizomes.

22. The method according to claim 2, wherein the composition is administered to the plant at least twice at an interval of from 1-21 days.

23. The method according to claim 2, wherein the composition is administered during the plant's seedling stage, transplant stage, vegetative stage, pre-bloom stage, full-bloom stage, post-bloom stage, fruit set stage, or dormancy.

24. The method according to claim 2, wherein the plant is a vegetable plant, a cereal plant, a fruit plant, a nut plant, or sugar cane.

25. The method according to claim 2, wherein the plant is a fruit tree.
